(19) United States
(12) Patent Application Publication
(10) Pub. No.: US 2026/0112975 A1
(43) Pub. Date: Apr. 23, 2026

(54) HYBRID BUCK CONVERTER, CHIP, AND ELECTRONIC DEVICE

(71) Applicant: Zhuhai Nanxin Semiconductor Technology Co., Ltd., Zhuhai (CN)

(72) Inventors: Boyang Yu, Zhuhai (CN); Yaohui Shi, Zhuhai (CN); Siyu He, Zhuhai (CN)

(73) Assignee: Zhuhai Nanxin Semiconductor Technology Co., Ltd., Zhuhai (CN)

(21) Appl. No.: 19/399,479

(22) Filed: Nov. 24, 2025

(30) Foreign Application Priority Data
Oct. 17, 2024 (CN) 202411453465.2

(51) Int. Cl. H02M 3/158; H02M 1/00; H02M 1/088; H02M 3/156

(52) U.S. Cl. CPC H02M 3/1586; H02M 1/0095; H02M 1/088; H02M 3/1566

(57) ABSTRACT

Provided are a hybrid buck converter, a chip, and an electronic device. In a buck mode, both the first single-phase buck converter circuit and the second single-phase buck converter circuit convert an input voltage at an input terminal according to a first voltage conversion ratio, such that a voltage across an output capacitor is acquired upon collaborative conversion of the input voltage by the first single-phase buck converter circuit and the second single-phase buck converter circuit. Therefore, due to parallel connection of the first single-phase buck converter circuit and the second single-phase buck converter circuit, smaller-sized inductors are allowed for use in both the first single-phase buck converter circuit and the second single-phase buck converter circuit. In this way, a total volume of the inductors in the hybrid buck converter is reduced, and thus the hybrid buck converter is suitable for use in volume-sensitive applications.

### CROSS REFERENCE TO THE RELATED APPLICATIONS

This application is based upon and claims priority to Chinese Patent Application No. 202411453465.2, filed on Oct. 17, 2024, the entire contents of which are incorporated herein by reference.

### TECHNICAL FIELD

The present disclosure relates to the technical field of electronics, and in particular, relates to a hybrid buck converter, a chip, and an electronic device.

### BACKGROUND

With the high power consumption demands of the 5G era, the battery capacity of electronic products such as mobile phones, smart watches, and tablet computers is continuously increasing. To address this, electronic products have adopted a dual-cell series battery architecture to increase fast-charging power, enabling quick and efficient charging to rapidly replenish the battery. This has become a standard feature in electronic products. Due to their high efficiency, hybrid buck converters are widely used for voltage conversion in the power supply systems of these dual-cell series battery architectures.

In the related art, the inductor current in a hybrid buck converter is a portion of the load current. Therefore, under heavy load current conditions, the hybrid buck converter requires a large-volume inductor to satisfy the requirements on the current of the individual inductor. This renders the hybrid buck converter unsuitable for volume-sensitive applications where the area or height of individual components is limited.

### SUMMARY

The present disclosure provides a hybrid buck converter, a chip, and an electronic device. A total volume of inductors in the hybrid buck converter is reduced, and thus the hybrid buck converter is suitable for use in volume-sensitive applications.

In a first aspect, some embodiments of the present disclosure provide a hybrid buck converter. The hybrid buck converter includes a first single-phase buck converter circuit, a second single-phase buck converter circuit, and an output capacitor; wherein the first single-phase buck converter circuit and the second single-phase buck converter circuit are connected in parallel between an input terminal of the hybrid buck converter and a first terminal of the output capacitor, and a second terminal of the output capacitor is electrically connected to a ground terminal of the hybrid buck converter; and the first single-phase buck converter circuit and the second single-phase buck converter circuit are configured to, in a case where the hybrid buck converter operates in a buck mode, convert an input voltage at the input terminal of the hybrid buck converter according to a first voltage conversion ratio.

In some embodiments, the first single-phase buck converter circuit and the second single-phase buck converter circuit are further configured to, in a case where the hybrid buck converter operates in a switched-capacitor mode, convert the input voltage according to a second voltage conversion ratio.

In some embodiments, the first single-phase buck converter circuit includes a first flying capacitor, a first switching transistor, a second switching transistor, a third switching transistor, a fourth switching transistor, a fifth switching transistor, and a first inductor; and the second single-phase buck converter circuit includes a second flying capacitor, a sixth switching transistor, a seventh switching transistor, an eighth switching transistor, a ninth switching transistor, a tenth switching transistor, and a second inductor.

A first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the third switching transistor, a second terminal of the third switching transistor is electrically connected to a first terminal of the fourth switching transistor, a second terminal of the fourth switching transistor is grounded, a first terminal of the fifth switching transistor is electrically connected to a first node, wherein the first node is disposed between the second terminal of the first switching transistor and the first terminal of the second switching transistor, a second terminal of the fifth switching transistor is electrically connected to a first terminal of the first inductor, a second terminal of the first inductor is electrically connected between the second terminal of the second switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to the first node, and a second terminal of the first flying capacitor is electrically connected to a second node, wherein the second node is located between the second terminal of the third switching transistor and the first terminal of the fourth switching transistor; and a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the tenth switching transistor is electrically connected to a third node, wherein the third node is disposed between the second terminal of the sixth switching transistor and the first terminal of the seventh switching transistor, a second terminal of the tenth switching transistor is electrically connected to a first terminal of the second inductor, a second terminal of the second inductor is electrically connected between the second terminal of the seventh switching transistor and the first terminal of the eighth switching transistor, the second terminal of the second inductor is further electrically connected to the output terminal of the hybrid buck converter, a first terminal of the second flying capacitor is electrically connected to the third node, and a second terminal of the second flying capacitor is electrically connected to a fourth node, wherein the fourth node is disposed between the second terminal of the eighth switching transistor and the first terminal of the ninth switch.

In some embodiments, the hybrid buck converter further includes an interleaving signal control circuit, wherein control terminals of the first switching transistor, the second switching transistor, the third switching transistor, the fourth switching transistor, the fifth switching transistor, the sixth switching transistor, the seventh switching transistor, the eighth switching transistor, the ninth switching transistor, and the tenth switching transistor are all electrically connected to the interleaving signal control circuit.

The interleaving signal control circuit is configured to: control the fifth switching transistor and the tenth switching transistor to be always turned on and the second switching transistor and the seventh switching transistor to be always turned off, and control the first switching transistor, the third switching transistor, the fourth switching transistor, the sixth switching transistor, the eighth switching transistor, and the ninth switching transistor to be switched between a turned-on state and a turned-off state, to cause the hybrid buck converter to operate in the buck mode; or control the fifth switching transistor and the tenth switching transistor to be always turned off, and control the first switching transistor, the second switching transistor, the third switching transistor, the fourth switching transistor, the sixth switching transistor, the seventh switching transistor, the eighth switching transistor, and the ninth switching transistor to be switched between the turned-on state and the turned-off state, to cause the hybrid buck converter to operate in the switched-capacitor mode.

In some embodiments, wherein the first single-phase buck converter circuit and the second single-phase buck converter circuit operate in an interleaved manner; and an interleaving angle between the first single-phase buck converter circuit and the second single-phase buck converter circuit is between 0° and 180°.

In some embodiments, wherein the hybrid buck converter supports four operating phases in the buck mode.

In a first operating phase: the first switching transistor, the third switching transistor, and the fifth switching transistor are in the turned-on state, the second switching transistor and the fourth switching transistor are in the turned-off state, the input voltage supplies power to the output capacitor sequentially via a path of the first switching transistor, the first flying capacitor and the third switching transistor and via another path of the first switching transistor, the fifth switching transistor and the first inductor, the first flying capacitor is charged, and the first inductor is magnetized; and the ninth switching transistor and the tenth switching transistor are in the turned-on state, the sixth switching transistor, the seventh switching transistor, and the eighth switching transistor are in the turned-off state, the second flying capacitor supplies power to the output capacitor via the tenth switching transistor and the second inductor, the second flying capacitor is discharged, and the second inductor is demagnetized.

In a second operating phase: the fourth switching transistor and the fifth switching transistor are in the turned-on state, the first switching transistor, the second switching transistor, and the third switching transistor are in the turned-off state, the first flying capacitor supplies power to the output capacitor via the fifth switching transistor and the first inductor, the first flying capacitor is discharged, and the first inductor is demagnetized; and the ninth switching transistor and the tenth switching transistor are in the turned-on state, the sixth switching transistor, the seventh switching transistor, and the eighth switching transistor are in the turned-off state, the second flying capacitor supplies power to the output capacitor via the tenth switching transistor and the second inductor, the second flying capacitor is discharged, and the second inductor is demagnetized.

In a third operating phase: the fourth switching transistor and the fifth switching transistor are in the turned-on state, the first switching transistor, the second switching transistor, and the third switching transistor are in the turned-off state, the first flying capacitor supplies power to the output capacitor via the fifth switching transistor and the first inductor, the first flying capacitor is discharged, and the first inductor is demagnetized; and the sixth switching transistor, the eighth switching transistor, and the tenth switching transistor are in the turned-on state, the seventh switching transistor and the ninth switching transistor are in the turned-off state, the input voltage supplies power to the output capacitor sequentially via a path of the sixth switching transistor, the second flying capacitor and the eighth switching transistor and via another path of the sixth switching transistor, the tenth switching transistor and the second inductor, the second flying capacitor is charged, and the second inductor is magnetized.

In a fourth operating phase: the first switching transistor, the third switching transistor, and the fifth switching transistor are in the turned-on state, the second switching transistor and the fourth switching transistor are in the turned-off state, the input voltage supplies power to the output capacitor sequentially via a path of the first switching transistor, the first flying capacitor and the third switching transistor and via another path of the first switching transistor, the fifth switching transistor and the first inductor, the first flying capacitor is charged, and the first inductor is magnetized; and the sixth switching transistor, the eighth switching transistor, and the tenth switching transistor are in the turned-on state, the seventh switching transistor and the ninth switching transistor are in the turned-off state, the input voltage supplies power to the output capacitor sequentially via a path of the sixth switching transistor, the second flying capacitor and the eighth switching transistor and via another path of the sixth switching transistor, the tenth switching transistor and the second inductor, the second flying capacitor is charged, and the second inductor is magnetized.

In some embodiments, the first single-phase buck converter circuit and the second single-phase buck converter circuit are further configured to, in a case where the hybrid buck converter operates in a switched-capacitor mode, convert the input voltage according to a second voltage conversion ratio.

In some embodiments, the hybrid buck converter supports two operating phases in the switched-capacitor mode; in a first operating phase: the first switching transistor and the third switching transistor are in the turned-on state, the second switching transistor, the fourth switching transistor, and the fifth switching transistor are in the turned-off state, the input voltage supplies power to the output capacitor via the first switching transistor, the first flying capacitor and the third switching transistor, and the first flying capacitor is charged; and the seventh switching transistor and the ninth switching transistor are in the turned-on state, the sixth switching transistor, the eighth switching transistor, and the tenth switching transistor are in the turned-off state, the second flying capacitor supplies power to the output capacitor via the seventh switching transistor, and the second flying capacitor is discharged; and in a second operating phase: the second switching transistor and the fourth switching transistor are in the turned-on state, the first switching transistor, the third switching transistor, and the fifth switching transistor are in the turned-off state, the first flying capacitor supplies power to the output capacitor via the second switching transistor, and the first flying capacitor is discharged; and the sixth switching transistor and the eighth switching transistor are in the turned-on state, the seventh switching transistor, the ninth switching transistor, and the tenth switching transistor are in the turned-off state, the input voltage supplies power to the output capacitor via the sixth switching transistor, the second flying capacitor and the eighth switching transistor, and the second flying capacitor is charged.

In some embodiments, a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the fifth switching transistor, a second terminal of the fifth switching transistor is electrically connected to a first terminal of the third switching transistor, a second terminal of the third switching transistor is electrically connected to a first terminal of the fourth switching transistor, a second terminal of the fourth switching transistor is grounded, a first terminal of the first inductor is electrically connected between the second terminal of the second switching transistor and the first terminal of the fifth switching transistor, a second terminal of the first inductor is electrically connected between the second terminal of the fifth switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to a first node, wherein the first node is disposed between the second terminal of the first switching transistor and the first terminal of the second switching transistor, and a second terminal of the first flying capacitor is electrically connected a second node, wherein the second node is disposed between the second terminal of the third switching transistor and the first terminal of the fourth switching transistor; and a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the tenth switching transistor, a second terminal of the tenth switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the second inductor is electrically connected between the second terminal of the seventh switching transistor and the first terminal of the tenth switching transistor, a second terminal of the second inductor is electrically connected between the second terminal of the tenth switching transistor and the first terminal of the eighth switching transistor, the second terminal of the second inductor is further electrically connected to the output terminal of the hybrid buck converter, a first terminal of the second flying capacitor is electrically connected to a third node, wherein the third node is disposed between the second terminal of the sixth switching transistor and the first terminal of the seventh switching transistor, and a second terminal of the second flying capacitor is electrically connected to a fourth node, wherein the fourth node is disposed between the second terminal of the eighth switching transistor and the first terminal of the ninth switching transistor.

In some embodiments, the hybrid buck converter further includes an interleaving signal control circuit, wherein control terminals of the first switching transistor, the second switching transistor, the third switching transistor, the fourth switching transistor, the fifth switching transistor, the sixth switching transistor, the seventh switching transistor, the eighth switching transistor, the ninth switching transistor, and the tenth switching transistor are all electrically connected to the interleaving signal control circuit.

The interleaving signal control circuit is configured to: control the fifth switching transistor and the tenth switching transistor to be always turned off and the second switching transistor and the seventh switching transistor to be always turned on, and control the first switching transistor, the third switching transistor, the fourth switching transistor, the sixth switching transistor, the eighth switching transistor, and the ninth switching transistor to be switched between the turned-on state and the turned-off state, to cause the hybrid buck converter to operate in the buck mode; or control the fifth switching transistor and the tenth switching transistor to be always turned on, and control the first switching transistor, the second switching transistor, the third switching transistor, the fourth switching transistor, the sixth switching transistor, the seventh switching transistor, the eighth switching transistor, and the ninth switching transistor to be switched between the turned-on state and the turned-off state, to cause the hybrid buck converter to operate in the switched-capacitor mode.

In some embodiments, the hybrid buck converter supports four operating phases in the buck mode.

In a first operating phase: the first switching transistor, the second switching transistor, and the third switching transistor are in the turned-on state, the fourth switching transistor and the fifth switching transistor are in the turned-off state, the input voltage supplies power to the output capacitor sequentially via a path of the first switching transistor, the first flying capacitor and the third switching transistor and via another path of the first switching transistor, the second switching transistor and the first inductor, the first flying capacitor is charged, and the first inductor is magnetized; and the seventh switching transistor and the ninth switching transistor are in the turned-on state, the sixth switching transistor, the eighth switching transistor, and the tenth switching transistor are in the turned-off state, the second flying capacitor supplies power to the output capacitor via the seventh switching transistor and the second inductor, the second flying capacitor is discharged, and the second inductor is demagnetized.

In a second operating phase: the second switching transistor and the fourth switching transistor are in the turned-on state, the first switching transistor, the third switching transistor, and the fifth switching transistor are in the turned-off state, the first flying capacitor supplies power to the output capacitor via the second switching transistor and the first inductor, the first flying capacitor is discharged, and the first inductor is demagnetized; and the seventh switching transistor and the ninth switching transistor are in the turned-on state, the sixth switching transistor, the eighth switching transistor, and the tenth switching transistor are in the turned-off state, the second flying capacitor supplies power to the output capacitor via the seventh switching transistor and the second inductor, the second flying capacitor is discharged, and the second inductor is demagnetized.

In a third operating phase: the second switching transistor and the fourth switching transistor are in the turned-on state, the first switching transistor, the third switching transistor, and the fifth switching transistor are in the turned-off state, the first flying capacitor supplies power to the output capacitor via the second switching transistor and the first inductor, the first flying capacitor is discharged, and the first inductor is demagnetized; and the sixth switching transistor, the seventh switching transistor, and the eighth switching transistor are in the turned-on state, the ninth switching transistor and the tenth switching transistor are in the turned-off state, the input voltage supplies power to the output capacitor sequentially via a path of the sixth switching transistor, the second flying capacitor and the eighth switching transistor and via another path of the sixth switching transistor, the seventh switching transistor and the second inductor, the second flying capacitor is charged, and the second inductor is magnetized.

In a fourth operating phase: the first switching transistor, the second switching transistor, and the third switching transistor are in the turned-on state, the fourth switching transistor and the fifth switching transistor are in the turned-off state, the input voltage supplies power to the output capacitor sequentially via a path of the first switching transistor, the first flying capacitor and the third switching transistor and via another path of the first switching transistor, the second switching transistor and the first inductor, the first flying capacitor is charged, and the first inductor is magnetized; and the sixth switching transistor, the seventh switching transistor, and the eighth switching transistor are in the turned-on state, the ninth switching transistor and the tenth switching transistor are in the turned-off state, the input voltage supplies power to the output capacitor sequentially via a path of the sixth switching transistor, the second flying capacitor and the eighth switching transistor and via another path of the sixth switching transistor, the seventh switching transistor and the second inductor, the second flying capacitor is charged, and the second inductor is magnetized.

In some embodiments, the first single-phase buck converter circuit and the second single-phase buck converter circuit are further configured to, in a case where the hybrid buck converter operates in a switched-capacitor mode, convert the input voltage according to a second voltage conversion ratio.

In some embodiments, the hybrid buck converter supports two operating phases in the switched-capacitor mode; in a first operating phase: the first switching transistor, the third switching transistor, and the fifth switching transistor are in the turned-on state, the second switching transistor and the fourth switching transistor are in the turned-off state, the input voltage supplies power to the output capacitor via the first flying capacitor, and the first flying capacitor is charged; and the seventh switching transistor, the ninth switching transistor, and the tenth switching transistor are in the turned-on state, the sixth switching transistor and the eighth switching transistor are in the turned-off state, the second flying capacitor supplies power to the output capacitor, and the second flying capacitor is discharged; and in a second operating phase: the second switching transistor, the fourth switching transistor, and the fifth switching transistor are in the turned-on state, the first switching transistor and the third switching transistor are in the turned-off state, the first flying capacitor supplies power to the output capacitor, and the first flying capacitor is discharged; and the sixth switching transistor, the eighth switching transistor, and the tenth switching transistor are in the turned-on state, the seventh switching transistor and the ninth switching transistor are in the turned-off state, the input voltage supplies power to the output capacitor via the second flying capacitor, and the second flying capacitor is charged.

In some embodiments, the first voltage conversion ratio is between 2:1 and 1:1, and the second voltage conversion ratio is 2:1.

In some embodiments, the hybrid buck converter is a step-down type hybrid buck converter or a step-up type hybrid buck converter.

In some embodiments, the hybrid buck converter further includes an input capacitor, wherein a first terminal of the input capacitor is electrically connected to the input terminal of the hybrid buck converter, and a second terminal of the input capacitor is electrically connected to the ground terminal.

In a second aspect, some embodiments of the present disclosure provide a chip. The chip includes the hybrid buck converter as described above.

In a third aspect, some embodiments of the present disclosure provide an electronic device. The electronic device includes the chip as described above.

In the hybrid buck converter, the chip, and the electronic device according to the present disclosure, due to the parallel connection of the first single-phase buck converter circuit and the second single-phase buck converter circuit, smaller-sized inductors are allowed for use in both the first single-phase buck converter circuit and the second single-phase buck converter circuit. In this way, a total volume of the inductors in the hybrid buck converter is reduced, and thus the hybrid buck converter is suitable for use in volume-sensitive applications.

The above description only summarizes the technical solutions of the embodiments of the present disclosure. Specific embodiments of the present disclosure are described hereinafter to better and clearer understand the technical solutions of the embodiments of the present disclosure, to practice the technical solutions based on the disclosure of the specification and to make the above and other objectives, features and advantages of the embodiments of the present disclosure more apparent and understandable.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic structural diagram of a buck converter in the related art.

FIG. 2A is a schematic diagram of a circuit state of the buck converter in FIG. 1 in a first stage.

FIG. 2B is a schematic diagram of a circuit state of the buck converter in FIG. 1 in a second stage.

FIG. 3 is a schematic structural diagram of a hybrid buck converter in the related art.

FIG. 4A is a schematic diagram of a circuit state of the hybrid buck converter in FIG. 3 in the first stage.

FIG. 4B is a schematic diagram of a circuit state of the hybrid buck converter in FIG. 3 in the second stage.

FIG. 5 is a schematic structural diagram of a hybrid buck converter, according to some embodiments of the present disclosure.

FIG. 6 is a schematic structural diagram of another hybrid buck converter, according to some embodiments of the present disclosure.

FIG. 7 is a schematic structural diagram of yet another hybrid buck converter according to some embodiments of the present disclosure.

FIG. 8A is a first schematic diagram of an equivalent circuit structure of the hybrid buck converter in FIG. 6 in a switched-capacitor mode.

FIG. 8B is a second schematic diagram of an equivalent circuit structure of the hybrid buck converter in FIG. 6 in a switched-capacitor mode.

FIG. 9A is a first schematic diagram of an equivalent circuit structure of the hybrid buck converter in FIG. 6 in a buck mode.

FIG. 9B is a second schematic diagram of an equivalent circuit structure of the hybrid buck converter in FIG. 6 in a buck mode.

FIG. 10A is a third schematic diagram of an equivalent circuit structure of the hybrid buck converter in FIG. 6 in a buck mode.

FIG. 10B is a fourth schematic diagram of an equivalent circuit structure of the hybrid buck converter in FIG. 6 in a buck mode.

FIG. 11A is a first schematic diagram of an equivalent circuit structure of the hybrid buck converter in FIG. 7 in a buck mode.

FIG. 11B is a second schematic diagram of an equivalent circuit structure of the hybrid buck converter in FIG. 7 in a buck mode.

FIG. 12A is a third schematic diagram of an equivalent circuit structure of the hybrid buck converter in FIG. 7 in a buck mode.

FIG. 12B is a fourth schematic diagram of an equivalent circuit structure of the hybrid buck converter in FIG. 7 in a buck mode.

FIG. 13 is a schematic diagram of a first type of operating waveforms of the hybrid buck converter in FIG. 6 in the buck mode.

FIG. 14 is a schematic diagram of a second type of operating waveforms of the hybrid buck converter in FIG. 6 in a buck mode.

### DETAILED DESCRIPTION OF THE EMBODIMENTS

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

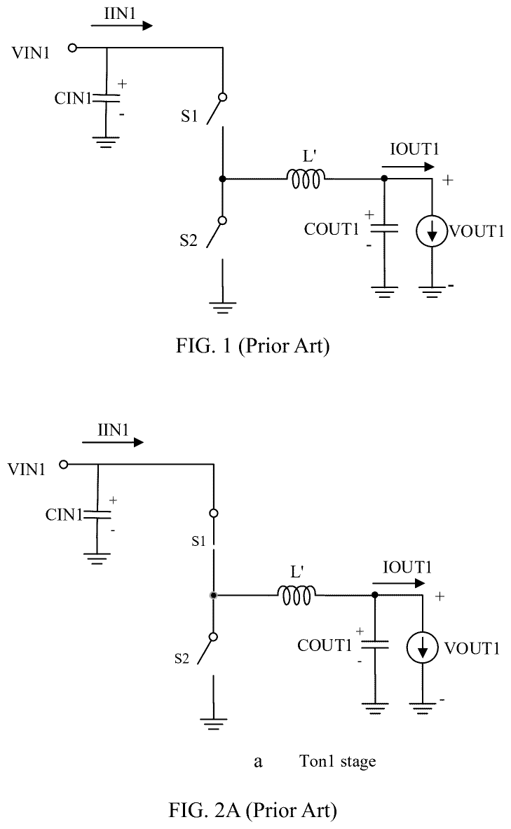

Referring to FIG. 1, FIG. 1 is a schematic structural diagram of a buck converter in the related art. As illustrated in FIG. 1, the buck converter in the related art may include a switching transistor S1, a switching transistor S2, an inductor L′, an input capacitor CIN1, an output capacitor COUT1, and an output load.

An input voltage VIN1 is applied to an input terminal of the buck converter. A first terminal of the input capacitor CIN1 and a first terminal of the switching transistor S1 are both electrically connected to the input terminal of the buck converter. A second terminal of the switching transistor S1 is electrically connected to a first terminal of the switching transistor S2 and a first terminal of the inductor L′. A second terminal of the input capacitor CIN1 and a second terminal of the switching transistor S2 are both grounded. A second terminal of the inductor L′ serves as an output terminal of the buck converter and is electrically connected to the output load. The second terminal of the inductor L′ is grounded via the output capacitor COUT1. The second terminal of the inductor L′ is configured to output an output voltage VOUT1 and a load current IOUT1.

The buck converter in the related art utilizes different switching states of the switching transistor S1 and the switching transistor S2 to enable the buck function for the output voltage VOUT1.

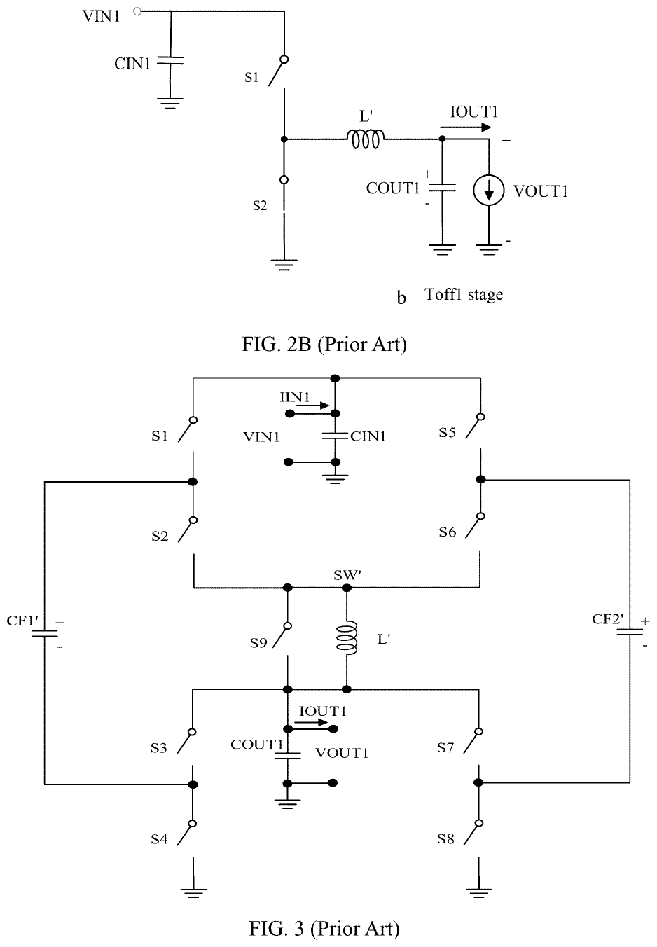

Referring to FIG. 2A, FIG. 2A is a schematic diagram of a circuit state of the buck converter in FIG. 1 in a first stage. As illustrated in FIG. 2A, in a first stage Ton1, the switching transistor S1 is turned on, and the switching transistor S2 is turned off. Thus, an input current IIN1 is supplied from the input voltage VIN1 to the output load via the switching transistor S1 and the inductor L′. During the first stage Ton1, the inductor L′ is magnetized, and a magnetization voltage across the inductor L′ is VIN1−VOUT1, wherein VIN1 represents the input voltage and VOUT1 represents the output voltage.

Referring to FIG. 2B, FIG. 2B is a schematic diagram of a circuit state of the buck converter in FIG. 1 in a second stage. As illustrated in FIG. 2B, in a second stage Toff1, the switching transistor S1 is turned off, and the switching transistor S2 is turned on. Thus, the input current IIN1 is supplied from the ground potential to the output load via the switching transistor S2 and the inductor L′. During the second stage Toff1, the inductor L′ is demagnetized, and a demagnetization voltage across the inductor L′ is −VOUT1.

Since a duty cycle of the first stage Ton1 is D1, based on the principle of volt-second balance, a voltage conversion ratio that may be achieved by the buck converter in the related art is: VOUT1=D1*VIN1 (0<D1<1).

Based on the above description, the voltage conversion ratio that may be achieved by the buck converter in the related art is between 0 and 1. Since the current of the inductor L′ is equal to a load current IOUT1, under heavy load current conditions, the buck converter in the related art requires a larger inductor size. At the same time, a DC resistance (DCR) of the inductor L′ and body diode freewheeling of the switching transistor introduce additional losses, leading to a lower conversion efficiency for the buck converter.

Referring to FIG. 3, FIG. 3 is a schematic structural diagram of a hybrid buck converter in the related art. As illustrated in FIG. 3, the hybrid buck converter in the related art may include switching transistors S1, S2, S3, S4, S5, S6, S7, S8, S9, flying capacitors CF1′ and CF2′, an inductor L′, an input capacitor CIN1, an output capacitor COUT1, and an output load.

An input voltage VIN1 is applied to an input terminal of the hybrid buck converter. A first terminal of the input capacitor CIN1, a first terminal of the switching transistor S1, and a first terminal of the switching transistor S5 are all electrically connected to the input terminal of the hybrid buck converter. A second terminal of the switching transistor S1 is electrically connected to a first terminal of the switching transistor S2 and a first terminal of the flying capacitor CF1′, respectively. A second terminal of the switching transistor S5 is electrically connected to a first terminal of the switching transistor S6 and a first terminal of the flying capacitor CF2′. A second terminal of the switching transistor S2 is electrically connected to a first terminal of the switching transistor S9, a first terminal of the inductor L′, and the first terminal of the switching transistor S6, respectively. A second terminal of the flying capacitor CF1′ is electrically connected to a first terminal of the switching transistor S3 and a first terminal of the switching transistor S4. A second terminal of the switching transistor S3 is electrically connected to a second terminal of the switching transistor S9, a second terminal of the inductor L′, a first terminal of the output capacitor COUT1, and a first terminal of the switching transistor S7. The second terminal of the inductor L′ serves as an output terminal of the hybrid buck converter and is electrically connected to the output load. A second terminal of the switching transistor S7 is electrically connected to a second terminal of the flying capacitor CF2′ and a first terminal of the switching transistor S8. A second terminal of the input capacitor CIN1, a second terminal of the output capacitor COUT1, a second terminal of the switching transistor S4, and a second terminal of the switching transistor S8 are all grounded. The second terminal of the inductor L′ is configured to output an output voltage VOUT1 and a load current IOUT1.

The hybrid buck converter in the related art utilizes different switching states of the switching transistors S1 to S9 to enable the output of an adjustable output voltage VOUT1. In addition, compared to the buck converter in FIGS. 1 and 2, the hybrid buck converter may improve the conversion efficiency.

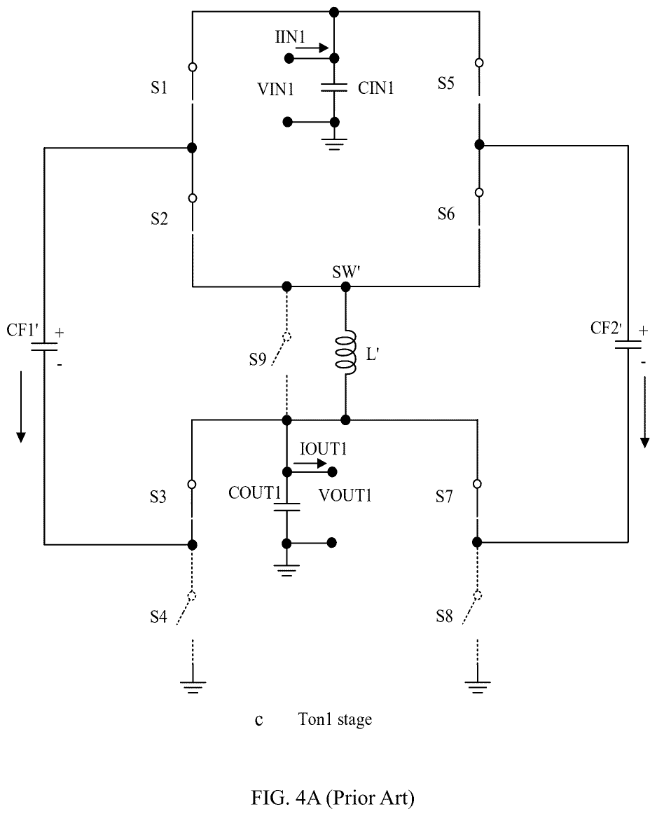

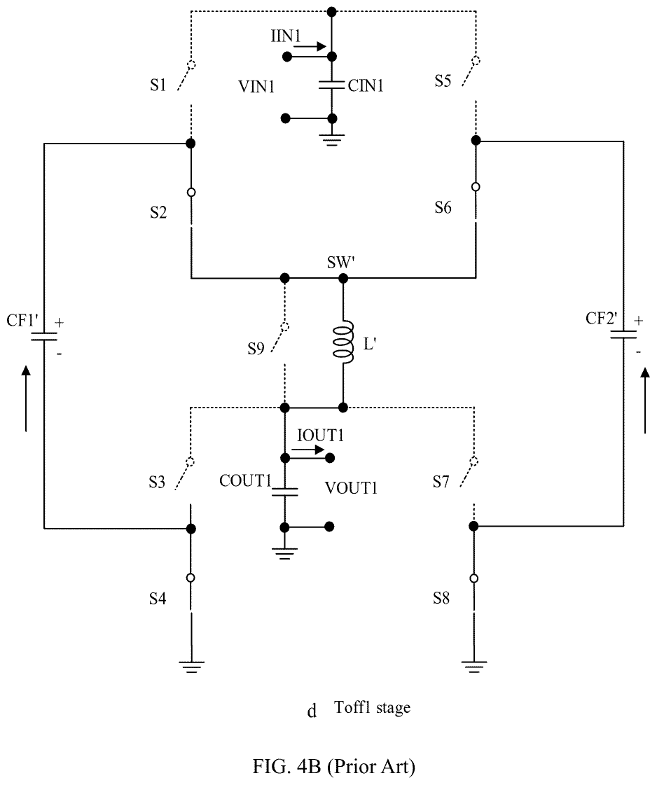

Referring to FIG. 4A, FIG. 4A is a schematic diagram of a circuit state of the hybrid buck converter in FIG. 3 in a first stage. As illustrated in FIG. 4A, in a first stage Ton1, the switching transistors S1, S2, S3, S5, S6, and S7 are turned on, and the switching transistors S4, S8, and S9 are turned off. Thus, the input voltage VIN1 supplies power to the output voltage VOUT1 via the flying capacitors CF1′ and CF2′, and the inductor L′. During the first stage Ton1, the flying capacitors CF1′ and CF2′ are charged, and the inductor L′ is magnetized.

Referring to FIG. 4B, FIG. 4B is a schematic diagram of a circuit state of the hybrid buck converter in FIG. 3 in a second stage. As illustrated in FIG. 4B, in a second stage Toff1, the switching transistors S2, S4, S6, and S8 are turned on, and the switching transistors S1, S3, S5, S7, and S9 are turned off. Thus, both the flying capacitor CF1′ and the flying capacitor CF2′ supply power to the output voltage VOUT1 via the inductor L′. During the second phase Toff1, the flying capacitors CF1′ and CF2′ are discharged, and the inductor L′ is demagnetized.

Since the hybrid buck converter in the related art still employs a single-inductor structure, in the first stage Ton1, the current of the inductor L′ only accounts for a portion of the output current (i.e., the load current IOUT1). This reduces the current of the inductor L′ and decrease the size of the inductor L′.

However, under heavy load current conditions, the hybrid buck converter in the related art still requires a large-volume inductor L′ to satisfy current-carrying capacity requirements of the inductor.

Based on the above description, both the buck converter and the hybrid buck converter in the related art require a large-volume inductor under heavy load current conditions. Therefore, in volume-sensitive applications where the area or height of components is limited, the selection of the inductor becomes a design bottleneck, rendering the buck converter and the hybrid buck converter in the related art unsuitable.

To solve the aforementioned technical problems, the present disclosure provides a hybrid buck converter, a chip, and an electronic device.

The hybrid buck converter may be a chip or a circuit module.

The electronic device may include the aforementioned chip.

In the present disclosure, the electronic device may include, but is not limited to, a switching power supply, a charger IC, and a motor driver.

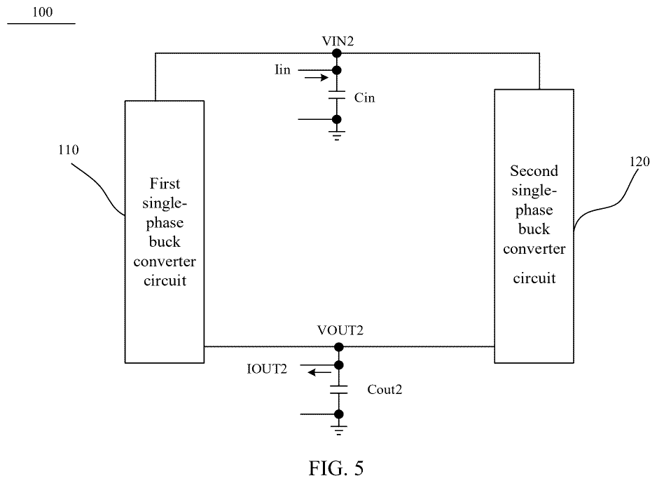

Referring to FIG. 5, FIG. 5 is a schematic structural diagram of a hybrid buck converter according to some embodiments of the present disclosure. As illustrated in FIG. 5, the hybrid buck converter 100 may include a first single-phase buck converter circuit 110, a second single-phase buck converter circuit 120, and an output capacitor Cout2.

The first single-phase buck converter circuit 110 and the second single-phase buck converter circuit 120 are connected in parallel between an input terminal of the hybrid buck converter 100 and a first terminal of the output capacitor Cout2. A second terminal of the output capacitor Cout2 is electrically connected to a ground terminal of the hybrid buck converter 100.

The first single-phase buck converter circuit 110, the second single-phase buck converter circuit 120, and the output capacitor Cout2 may be disposed separately or integrated together.

The first terminal of the output capacitor Cout2 serves as an output terminal of the hybrid buck converter 100. That is, a voltage across the output capacitor Cout2 is an output voltage VOUT2 of the hybrid buck converter 100.

In some examples, the hybrid buck converter 100 may further include an input capacitor Cin.

A first terminal of the input capacitor Cin is electrically connected to the input terminal of the hybrid buck converter 100, and a second terminal of the input capacitor Cin is electrically connected to the ground terminal of the hybrid buck converter 100.

The input capacitor Cin may filter an input voltage VIN2 at the input terminal to eliminate ripples therein.

In some examples, the hybrid buck converter 100 may be configured to perform both boost and buck operations.

For example, in a case where the first terminal of the input capacitor Cin serves as the input terminal of the hybrid buck converter 100 for receiving the input voltage, and the first terminal of the output capacitor Cout2 serves as the output terminal of the hybrid buck converter 100 for outputting the output voltage, then the hybrid buck converter 100 is configured to perform the buck operation. That is, the hybrid buck converter is a step-down type hybrid buck converter.

As another example, in a case where the first terminal of the output capacitor Cout2 serves as the input terminal of the hybrid buck converter 100 for receiving the input voltage, and the first terminal of the input capacitor Cin serves as the output terminal of the hybrid buck converter 100 for outputting the output voltage, then the hybrid buck converter 100 is configured to perform the boost operation, That is, the hybrid buck converter 100 is a step-up type hybrid buck converter.

In a case where the input voltage VIN2 at the input terminal is less than a predetermined voltage, the hybrid buck converter 100 operates in a buck mode, and converts the input voltage VIN2 according to a first voltage conversion ratio.

In the buck mode, both the first single-phase buck converter circuit 110 and the second single-phase buck converter circuit 120 convert the input voltage VIN2 according to the first voltage conversion ratio, such that the voltage across the output capacitor Cout2, i.e., the output voltage VOUT2, is acquired upon collaborative conversion of the input voltage VIN2 by the first single-phase buck converter circuit 110 and the second single-phase buck converter circuit 120. That is, both the first single-phase buck converter circuit 110 and the second single-phase buck converter circuit 120 are in an operating state.

A sum of currents of inductors in the first single-phase buck converter circuit 110 and the second single-phase buck converter circuit 120 is an output current IOUT2 of the hybrid buck converter 100. This implies that the currents flowing through the inductors in the first single-phase buck converter circuit 110 and the second single-phase buck converter circuit 120 are both small. Therefore, due to the parallel connection of the first single-phase buck converter circuit 110 and the second single-phase buck converter circuit 120, the currents in the inductors in the first single-phase buck converter circuit 110 and the second single-phase buck converter circuit 120 are both small, allowing for the use of smaller-sized inductors in both the first single-phase buck converter circuit 110 and the second single-phase buck converter circuit 120. In this way, a total volume of the inductors in the hybrid buck converter 100 is reduced, and thus the hybrid buck converter is suitable for use in volume-sensitive applications.

In some examples, in a case where the input voltage VIN2 at the input terminal is greater than or equal to the predetermined voltage, the hybrid buck converter 100 operates in a switched-capacitor mode, and converts the input voltage VIN2 according to a second voltage conversion ratio.

In the switched-capacitor mode, both the first single-phase buck converter circuit 110 and the second single-phase buck converter circuit 120 convert the input voltage VIN2 at the input terminal according to the second voltage conversion ratio, such that the voltage across the output capacitor Cout2, i.e., the output voltage VOUT2 of the hybrid buck converter 100, is acquired upon collaborative conversion of the input voltage VIN2 at the input terminal by the first single-phase buck converter circuit 110 and the second single-phase buck converter circuit 120. That is, both the first single-phase buck converter circuit 110 and the second single-phase buck converter circuit 120 are in an operating state.

Since the hybrid buck converter 100 is capable of operating in both the buck mode and the switched-capacitor mode, the hybrid buck converter 100 may satisfy the requirements of both the first conversion ratio and the second voltage conversion ratio. This allows the hybrid buck converter 100 to be used in scenarios with a wider range of voltage conversion ratios, thereby effectively extending the standby time of the load, i.e., the electronic product.

In some embodiments, the first voltage conversion ratio is between 2:1 and 1:1, inclusive of the endpoints. Thus, a conversion ratio between the input voltage VIN2 of the hybrid buck converter 100 and the output voltage VOUT2 of the hybrid buck converter 100 is between 2:1 and 1:1, inclusive of the endpoints, i.e., VOUT2=VIN2/2 to VIN2.

In some examples, the second voltage conversion ratio is 2:1. Thus, the conversion ratio between the input voltage VIN2 of the hybrid buck converter 100 and the output voltage VOUT2 of the hybrid buck converter 100 is 2:1, i.e., VOUT2=VIN2/2.

In summary, by incorporating the switched-capacitor mode in addition to the buck mode during operation, the hybrid buck converter may select, based on the input voltage at the input terminal, whether to operate in the buck mode or in the switched-capacitor mode. This enables the hybrid buck converter to be applied in scenarios with a wider range of voltage conversion ratios, thereby effectively extending the standby time of the load.

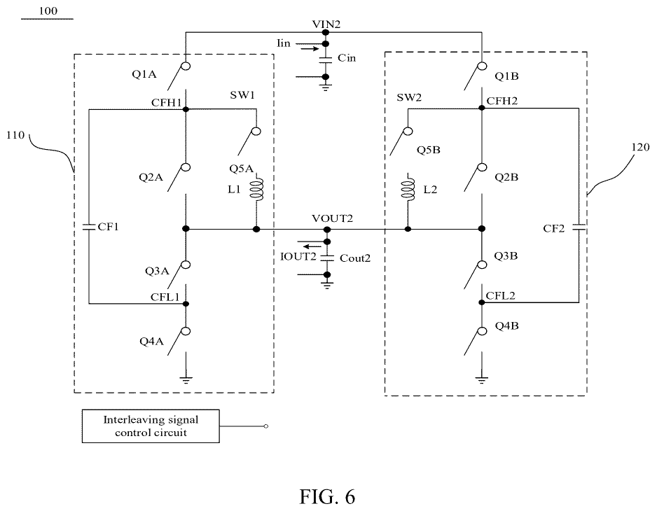

As an example, a possible implementation of the first single-phase buck converter circuit 110 and the second single-phase buck converter circuit 120 is illustrated in FIG. 6. FIG. 6 illustrates a circuit structure for the circuits in FIG. 5. As illustrated in FIG. 6, the first single-phase buck converter circuit 110 includes a first flying capacitor CF1, a first switching transistor Q1A, a second switching transistor Q2A, a third switching transistor Q3A, a fourth switching transistor Q4A, a fifth switching transistor Q5A, and a first inductor L1. The second single-phase buck converter circuit 120 may include a second flying capacitor CF2, a sixth switching transistor Q1B, a seventh switching transistor Q2B, an eighth switching transistor Q3B, a ninth switching transistor Q4B, a tenth switching transistor Q5B, and a second inductor L2.

The first switching transistor Q1A, the second switching transistor Q2A, the third switching transistor Q3A, and the fourth switching transistor Q4A are connected in series between the input terminal and the ground terminal of the hybrid buck converter 100, wherein a first terminal of the first switching transistor Q1A is electrically connected to the input terminal of the hybrid buck converter 100, a second terminal of the first switching transistor Q1A is electrically connected to a first terminal of the second switching transistor Q2A, a second terminal of the second switching transistor Q2A is electrically connected to a first terminal of the third switching transistor Q3A, a second terminal of the third switching transistor Q3A is electrically connected to a first terminal of the fourth switching transistor Q4A, and a second terminal of the fourth switching transistor Q4A is electrically connected to the ground terminal of the hybrid buck converter 100. The fifth switching transistor Q5A and the first inductor L1 are connected in series, and this series combination is connected in parallel with the second switching transistor Q2A. For example, the first terminal of the fifth switching transistor Q5A is electrically connected to a first node CFH1, which is disposed between the second terminal of the first switching transistor Q1A and the first terminal of the second switching transistor Q2A. The second terminal of the fifth switching transistor Q5A is electrically connected to a first terminal of the first inductor L1, and a second terminal of the first inductor L1 is electrically connected between the second terminal of the second switching transistor Q2A and the first terminal of the third switching transistor Q3A. The series combination of the fifth switching transistor Q5A and the first inductor L1 is also electrically connected to the first terminal of the output capacitor Cout2. For example, the second terminal of the first inductor L1 is electrically connected to the first terminal of the output capacitor Cout2, and the second terminal of the output capacitor Count2 is connected to the ground terminal. The first flying capacitor CF1 is connected in parallel to the series combination of the second switching transistor Q2A and the third switching transistor Q3A. For example, a first terminal of the first flying capacitor CF1 is electrically connected to the first node CFH1, and a second terminal of the first flying capacitor CF1 is electrically connected to a second node CFL1. The second node CFL1 is disposed between the second terminal of the third switching transistor Q3A and the first terminal of the fourth switching transistor Q4A.

The sixth switching transistor Q1B, the seventh switching transistor Q2B, the eighth switching transistor Q3B, and the ninth switching transistor Q4B are connected in series between the input terminal and the ground terminal of the hybrid buck converter 100. A first terminal of the sixth switching transistor Q1B is electrically connected to the input terminal of the hybrid buck converter 100, a second terminal of the sixth switching transistor Q1B is electrically connected to a first terminal of the seventh switching transistor Q2B, a second terminal of the seventh switching transistor Q2B is electrically connected to a first terminal of the eighth switching transistor Q3B, a second terminal of the eighth switching transistor Q3B is electrically connected to a first terminal of the ninth switching transistor Q4B, and a second terminal of the ninth switching transistor Q4B is electrically connected to the ground terminal. The tenth switching transistor Q5B and the second inductor L2 are connected in series, and this series combination is connected in parallel to the seventh switching transistor Q2B. For example, the first terminal of the tenth switching transistor Q5B is electrically connected to a third node CFH2 which is disposed between the second terminal of the sixth switching transistor Q1B and the first terminal of the seventh switching transistor Q2B. The second terminal of the tenth switching transistor Q5B is electrically connected to a first terminal of the second inductor L2, and a second terminal of the second inductor L2 is electrically connected between the second terminal of the seventh switching transistor Q2B and the first terminal of the eighth switching transistor Q3B. The series combination of the tenth switching transistor Q5B and the second inductor L2 is also electrically connected to the first terminal of the output capacitor Cout2. For example, the second terminal of the second inductor L2 is electrically connected to the first terminal of the output capacitor Cout2. The second flying capacitor CF2 is connected in parallel to the series combination of the seventh switching transistor Q2B and the eighth switching transistor Q3B. For example, a first terminal of the second flying capacitor CF2 is electrically connected to the third node CFH2, and a second terminal of the second flying capacitor CF2 is electrically connected to a fourth node CFL2. The fourth node CFL2 is disposed between the second terminal of the eighth switching transistor Q3B and the first terminal of the ninth switching transistor Q4B.

The first terminal of the fifth switching transistor Q5A is a fifth node SW1, and the first terminal of the tenth switching transistor Q5B is a sixth node SW2.

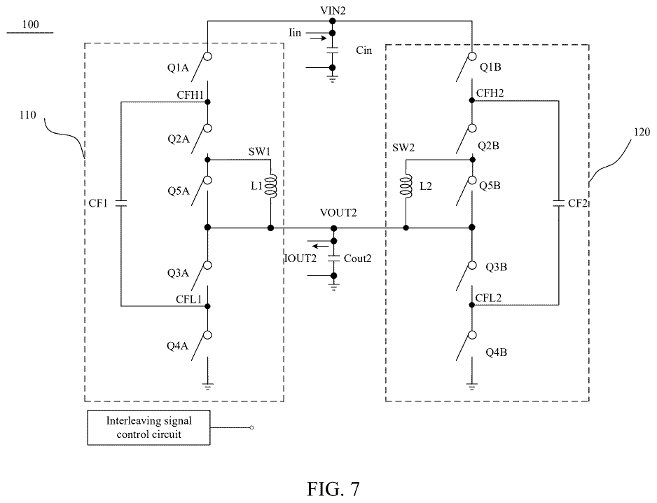

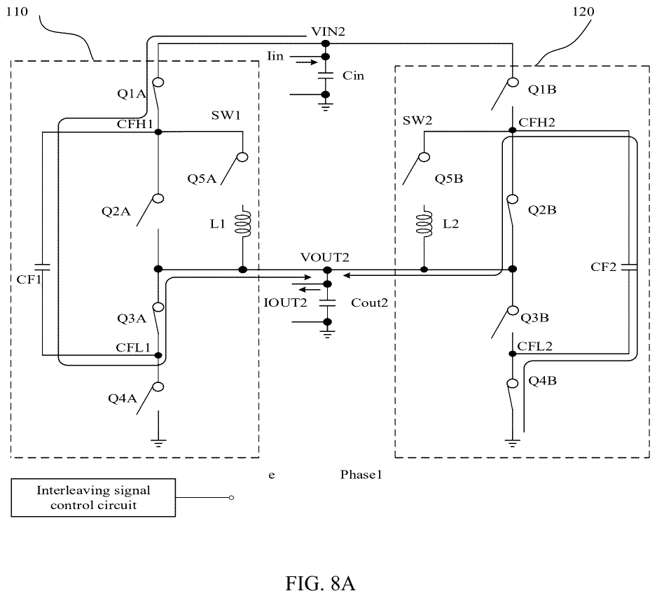

In another embodiment of the present disclosure, the first single-phase buck converter circuit 110 and the second single-phase buck converter circuit 120 may have another circuit structure, as illustrated in FIG. 7. FIG. 7 illustrates another circuit structure for the first single-phase buck converter circuit and the second single-phase buck converter circuit in FIG. 5.

As illustrated in FIG. 7, the first switching transistor Q1A, the second switching transistor Q2A, the fifth switching transistor Q5A, the third switching transistor Q3A, and the fourth switching transistor Q4A are connected in series between the input terminal and the ground terminal of the hybrid buck converter 100. A first terminal of the first switching transistor Q1A is electrically connected to the input terminal of the hybrid buck converter 100, a second terminal of the first switching transistor Q1A is electrically connected to a first terminal of the second switching transistor Q2A, a second terminal of the second switching transistor Q2A is electrically connected to a first terminal of the fifth switching transistor Q5A, a second terminal of the fifth switching transistor Q5A is electrically connected to a first terminal of the third switching transistor Q3A, a second terminal of the third switching transistor Q3A is electrically connected to a first terminal of the fourth switching transistor Q4A, and a second terminal of the fourth switching transistor Q4A is electrically connected to the ground terminal. The first inductor L1 is connected in parallel to the fifth switching transistor Q5A. For example, a first terminal of the first inductor L1 is electrically connected between the second terminal of the second switching transistor Q2A and the first terminal of the fifth switching transistor Q5A, and a second terminal of the first inductor L1 is electrically connected between the second terminal of the fifth switching transistor Q5A and the first terminal of the third switching transistor Q3A. The first flying capacitor CF1 is connected in parallel to the series combination of the second switching transistor Q2A, the fifth switching transistor Q5A, and the third switching transistor Q3A. For example, a first terminal of the first flying capacitor CF1 is electrically connected to the first node CFH1 which is disposed between the second terminal of the first switching transistor Q1A and the first terminal of the second switching transistor Q2A, and a second terminal of the first flying capacitor CF1 is electrically connected between the second terminal of the third switching transistor Q3A and the first terminal of the fourth switching transistor Q4A. The parallel combination of the first inductor L1 and the fifth switching transistor Q5A is also electrically connected to the first terminal of the output capacitor Cout2. For example, the first terminal of the output capacitor Cout2 is electrically connected to the second terminal of the fifth switching transistor Q5A and the second terminal of the first inductor L1.

The sixth switching transistor Q1B, the seventh switching transistor Q2B, the tenth switching transistor Q5B, the eighth switching transistor Q3B, and the ninth switching transistor Q4B are connected in series between the input terminal and the ground terminal of the hybrid buck converter 100. A first terminal of the sixth switching transistor Q1B is electrically connected to the input terminal of the hybrid buck converter 100, a second terminal of the sixth switching transistor Q1B is electrically connected to a first terminal of the seventh switching transistor Q2B, a second terminal of the seventh switching transistor Q2B is electrically connected to a first terminal of the tenth switching transistor Q5B, a second terminal of the tenth switching transistor Q5B is electrically connected to a first terminal of the eighth switching transistor Q3B, a second terminal of the eighth switching transistor Q3B is electrically connected to a first terminal of the ninth switching transistor Q4B, and a second terminal of the ninth switching transistor Q4B is electrically connected to the ground terminal. The second inductor L2 is connected in parallel with the tenth switching transistor Q5B. For example, a first terminal of the second inductor L2 is electrically connected between the second terminal of the seventh switching transistor Q2B and the first terminal of the tenth switching transistor Q5B, and a second terminal of the second inductor L2 is electrically connected between the second terminal of the tenth switching transistor Q5B and the first terminal of the eighth switching transistor Q3B. The second flying capacitor CF2 is connected in parallel to the series combination of the seventh switching transistor Q2B, the tenth switching transistor Q5B, and the eighth switching transistor Q3B. For example, a first terminal of the second flying capacitor CF2 is electrically connected to the third node CFH2 which is disposed between the second terminal of the sixth switching transistor Q1B and the first terminal of the seventh switching transistor Q2B, and a second terminal of the second flying capacitor CF2 is electrically connected to the fourth node CFL2 which is disposed between the second terminal of the eighth switching transistor Q3B and the first terminal of the ninth switching transistor Q4B. The parallel combination of the second inductor L2 and the tenth switching transistor Q5B is also electrically connected to the first terminal of the output capacitor Cout2. For example, the first terminal of the output capacitor Cout2 is electrically connected to the second terminal of the tenth switching transistor Q5B and the second terminal of the second inductor L2, respectively.

The first terminal of the first inductor L1 is a fifth node SW1, and the first terminal of the second inductor L2 is a sixth node SW2.

In some examples, as illustrated in FIGS. 6 and 7, the hybrid buck converter 100 may further include an interleaving signal control circuit. Control terminals of the first switching transistor Q1A, the second switching transistor Q2A, the third switching transistor Q3A, the fourth switching transistor Q4A, the fifth switching transistor Q5A, the sixth switching transistor Q1B, the seventh switching transistor Q2B, the eighth switching transistor Q3B, the ninth switching transistor Q4B, and the tenth switching transistor Q5B are all electrically connected to the interleaving signal control circuit.

In an embodiment of the present disclosure, for the hybrid buck converter 100 illustrated in FIG. 6, the interleaving signal control circuit may be configured to control the fifth switching transistor Q5A and the tenth switching transistor Q5B to be always turned on, and the second switching transistor Q2A and the seventh switching transistor Q2B to be always turned off; and control the first switching transistor Q1A, the third switching transistor Q3A, the fourth switching transistor Q4A, the sixth switching transistor Q1B, the eighth switching transistor Q3B, and the ninth switching transistor Q4B to be switched between a turned-on state and a turned-off state. In this way, both the first single-phase buck converter circuit 110 and the second single-phase buck converter circuit 120 operate in the buck mode, and thus the hybrid buck converter 100 operates in the buck mode.

In another embodiment of the present disclosure, for the hybrid buck converter 100 illustrated in FIG. 6, the interleaving signal control circuit may be configured to control the fifth switching transistor Q5A and the tenth switching transistor Q5B to be always turned off; and control the first switching transistor Q1A, the second switching transistor Q2A, the third switching transistor Q3A, the fourth switching transistor Q4A, the sixth switching transistor Q1B, the seventh switching transistor Q2B, the eighth switching transistor Q3B, and the ninth switching transistor Q4B to be switched between the turned-on state and the turned-off state. In this manner, in the first single-phase buck converter circuit 110, the first inductor L1 is in an open-circuit state, such that the first inductor L1 is inactive and the first single-phase buck converter circuit 110 is in the switched-capacitor mode. In the second single-phase buck converter circuit 120, the second inductor L2 is in an open-circuit state, such that the second inductor L2 is inactive and the second single-phase buck converter circuit 120 is in the switched-capacitor mode. Thus, the hybrid buck converter 100 operates in the switched-capacitor mode.

In another embodiment of the present disclosure, for the hybrid buck converter 100 illustrated in FIG. 7, the interleaving signal control circuit can be configured to control the fifth switching transistor Q5A and the tenth switching transistor Q5B to be always turned off, and the second switching transistor Q2A and the seventh switching transistor Q2B to be always turned on; and control the first switching transistor Q1A, the third switching transistor Q3A, the fourth switching transistor Q4A, the sixth switching transistor Q1B, the eighth switching transistor Q3B, and the ninth switching transistor Q4B to be switched between a turned-on state and a turned-off state. In this way, both the first single-phase buck converter circuit 110 and the second single-phase buck converter circuit 120 operate in the buck mode, and thus the hybrid buck converter 100 operates in the buck mode.

In another embodiment of the present disclosure, for the hybrid buck converter 100 illustrated in FIG. 7, the interleaving signal control circuit may be configured to control the fifth switching transistor Q5A and the tenth switching transistor Q5B to be always turned on; and control the first switching transistor Q1A, the second switching transistor Q2A, the third switching transistor Q3A, the fourth switching transistor Q4A, the sixth switching transistor Q1B, the seventh switching transistor Q2B, the eighth switching transistor Q3B, and the ninth switching transistor Q4B to be switched between the turned-on state and the turned-off state. In this way, both the first single-phase buck converter circuit 110 and the second single-phase buck converter circuit 120 operate in the switched-capacitor mode, and thus the hybrid buck converter 100 operates in the switched-capacitor mode.

In summary, by controlling the turned-on and turned-off states of the respective switching transistors via the interleaving signal control circuit, the hybrid buck converter operates in either the buck mode or the switched-capacitor mode. This allows the hybrid buck converter to be compatible with both modes to satisfy the requirements of different voltage conversion ratios.

In some examples, the first single-phase buck converter circuit 110 and the second single-phase buck converter circuit 120 operate in an interleaved manner.

An interleaving angle between the first single-phase buck converter circuit 110 and the second single-phase buck converter circuit 120 is between 0° and 180°. That is, the interleaving time between the first single-phase buck converter circuit 110 and the second single-phase buck converter circuit 120 is not fixed.

For example, by controlling turn-on or turn-off the switching transistors in the first single-phase buck converter circuit 110, the first flying capacitor CF1 starts to charge at a first time; and by controlling turn-on or turn-off of the switching transistors in the second single-phase buck converter circuit 120, the second flying capacitor CF2 starts to charge at a second time. A time difference is present between the first time and the second time, that is, interleaving time is not zero. Thus, the first single-phase buck converter circuit 110 and the second single-phase buck converter circuit 120 operate in an interleaved manner.

In a case where the interleaving angle between the first single-phase buck converter circuit 110 and the second single-phase buck converter circuit 120 is 0°, that is, the interleaving time between the first single-phase buck converter circuit 110 and the second single-phase buck converter circuit 120 is 0, no time difference is present between the first time and the second time, i.e., the first flying capacitor CF1 and the second flying capacitor CF2 start charging simultaneously. In this case, the first single-phase buck converter circuit 110 and the second single-phase buck converter circuit 120 are in phase.

An interleaving angle of 180° between the first single-phase buck converter circuit 110 and the second single-phase buck converter circuit 120 means that the interleaving time between the first single-phase buck converter circuit 110 and the second single-phase buck converter circuit 120 is 50% of a period.

In the embodiments of the present disclosure, regardless of whether the hybrid buck converter 100 is in the buck mode or the switched-capacitor mode, the first single-phase buck converter circuit 110 and the second single-phase buck converter circuit 120 operate in an interleaved state. This suppresses the ripple in the output voltage VOUT2 of the hybrid buck converter 100. In a case where the interleaving time between the first single-phase buck converter circuit 110 and the second single-phase buck converter circuit 120 is 50% of the period, the ripple of the output voltage VOUT2 is minimized. That is, the suppression effect on the ripple of the output voltage VOUT2 is optimal.

In a case where the hybrid buck converter 100 is in the buck mode, the interleaved operation of the first single-phase buck converter circuit 110 and the second single-phase buck converter circuit 120 reduces the ripple of the total output current IOUT2 of the hybrid buck converter 100, and the output voltage ripple is significantly lowered. As such, both the first single-phase buck converter circuit 110 and the second single-phase buck converter circuit 120 may use inductors with smaller inductance values while maintaining the same level of output voltage ripple. This further reduces the volumes of the inductors in both the first single-phase buck converter circuit 110 and the second single-phase buck converter circuit 120.

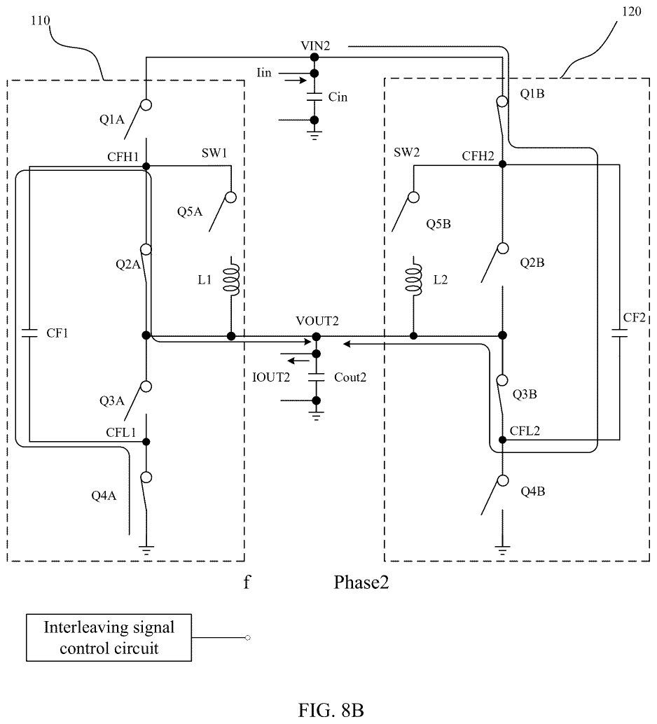

Hereinafter, with reference to FIGS. 8A and 8B, a detailed description of the two operating phases of the hybrid buck converter 100 in the switched-capacitor mode is provided. FIG. 8A is a first schematic diagram of an equivalent circuit structure of the hybrid buck converter in FIG. 6 in the switched-capacitor mode, and FIG. 8B is a second schematic diagram of an equivalent circuit structure of the hybrid buck converter in FIG. 6 in the switched-capacitor mode.

As illustrated in FIG. 8A, in a first operating phase Phase1, with respect to the first single-phase buck converter circuit 110, the interleaving signal control circuit controls the first switching transistor Q1A and the third switching transistor Q3A to be turned on, and controls the second switching transistor Q2A, the fourth switching transistor Q4A, and the fifth switching transistor Q5A to be turned off. The input voltage VIN2 at the input terminal supplies power to the output capacitor Cout2, i.e., the output voltage VOUT2, sequentially via the first switching transistor Q1A, the first flying capacitor CF1, and the third switching transistor Q3A, and the first flying capacitor CF1 is charged. That is, the first single-phase buck converter circuit 110 is in a charging stage.

In the first operating phase Phase1, with respect to the second single-phase buck converter circuit 120, the interleaving signal control circuit controls the seventh switching transistor Q2B and the ninth switching transistor Q4B to be turned on, and controls the sixth switching transistor Q1B, the eighth switching transistor Q3B, and the tenth switching transistor Q5B to be turned off. The second flying capacitor CF2 supplies power to the output capacitor Cout2 via the seventh switching transistor Q2B, and the second flying capacitor CF2 is discharged. That is, the second single-phase buck converter circuit 120 is in a discharging stage.

In summary, in the first operating phase Phase1, the first single-phase buck converter circuit 110 is in the charging stage, and the second single-phase buck converter circuit 120 is in the discharging stage.

As illustrated in FIG. 8B, in a second operating phase Phase2, with respect to the first single-phase buck converter circuit 110, the interleaving signal control circuit controls the second switching transistor Q2A and the fourth switching transistor Q4A to be turned on, and controls the first switching transistor Q1A, the third switching transistor Q3A, and the fifth switching transistor Q5A to be turned off. The first flying capacitor CF1 supplies power to the output capacitor Cout2 via the second switching transistor Q2A, and the first flying capacitor CF1 is discharged. That is, the first single-phase buck converter circuit 110 is in a discharging stage.

In the second operating phase Phase2, with respect to the second single-phase buck converter circuit 120, the interleaving signal control circuit controls the sixth switching transistor Q1B and the eighth switching transistor Q3B to be turned on, and controls the seventh switching transistor Q2B, the ninth switching transistor Q4B, and the tenth switching transistor Q5B to be turned off. The input voltage VIN2 at the input terminal supplies power to the output capacitor Cout2 sequentially via the sixth switching transistor Q1B, the second flying capacitor CF2, and the eighth switching transistor Q3B, and the second flying capacitor CF2 is charged. That is, the second single-phase buck converter circuit 120 is in a charging stage.

In summary, in the second operating phase Phase2, the first single-phase buck converter circuit 110 is in the discharging stage, and the second single-phase buck converter circuit 120 is in the charging stage.

Similarly, the hybrid buck converter in FIG. 7 also supports two operating phases in the switched-capacitor mode.

In the first operating phase Phase1, with respect to the first single-phase buck converter circuit 110, the interleaving signal control circuit controls the first switching transistor Q1A, the third switching transistor Q3A, and the fifth switching transistor Q5A to be in a turned-on state, and the second switching transistor Q2A and the fourth switching transistor Q4A to be in a turned-off state; and the input voltage VIN2 supplies power to the output capacitor Cout2 sequentially via the first switching transistor Q1A, the first flying capacitor CF1, and the third switching transistor Q3A, and the first flying capacitor CF1 is charged. With respect to the second single-phase buck converter circuit 120, the seventh switching transistor Q2B, the ninth switching transistor Q4B, and the tenth switching transistor Q5B are in a turned-on state, and the sixth switching transistor Q1B and the eighth switching transistor Q3B are in a turned-off state; and the second flying capacitor CF2 supplies power to the output capacitor Cout2 sequentially via the seventh switching transistor Q2B and the tenth switching transistor Q5B, and the second flying capacitor CF2 is discharged.

In the second operating phase Phase2, with respect to the first single-phase buck converter circuit 110, the second switching transistor Q2A, the fourth switching transistor Q4A, and the fifth switching transistor Q5A are in a turned-on state, and the first switching transistor Q1A and the third switching transistor Q3A are in a turned-off state; and the first flying capacitor CF1 supplies power to the output capacitor Cout2 sequentially via the second switching transistor Q2A and the fifth switching transistor Q5A, and the first flying capacitor CF1 is discharged. With respect to the second single-phase buck converter circuit 120, the sixth switching transistor Q1B, the eighth switching transistor Q3B, and the tenth switching transistor Q5B are in a turned-on state, and the seventh switching transistor Q2B and the ninth switching transistor Q4B are in a turned-off state; and the input voltage VIN2 supplies power to the output capacitor Cout2 sequentially via the sixth switching transistor Q1B, the second flying capacitor CF2, and the eighth switching transistor Q3B, and the second flying capacitor CF2 is charged.

In the switched-capacitor mode, a duty cycle of the first operating phase Phase1 is 50%, and a duty cycle of the second operating phase Phase2 is 50%. In this way, the output voltage VOUT2=VCF1=VCF2=VIN2/2, wherein VCF1 represents a voltage across the first flying capacitor CF1, and VCF2 represents a voltage across the second flying capacitor CF2. That is, the switched-capacitor mode is a 2:1 switched-capacitor mode.

Since the first single-phase buck converter circuit 110 and the second single-phase buck converter circuit 120 operate in an interleaved manner, the hybrid buck converter 100 supports a total of four operating phases in the buck mode. Hereinafter, the four operating phases of the hybrid buck converter 100 in the buck mode are described in detail.

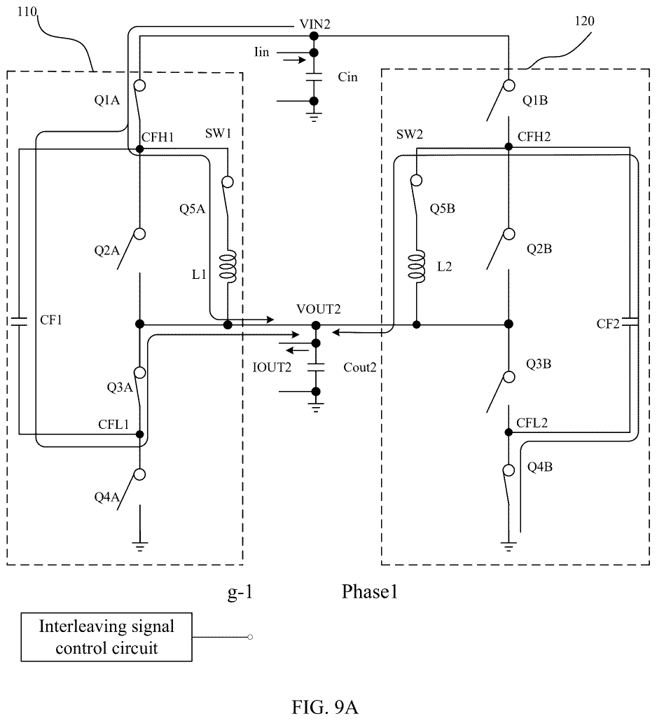

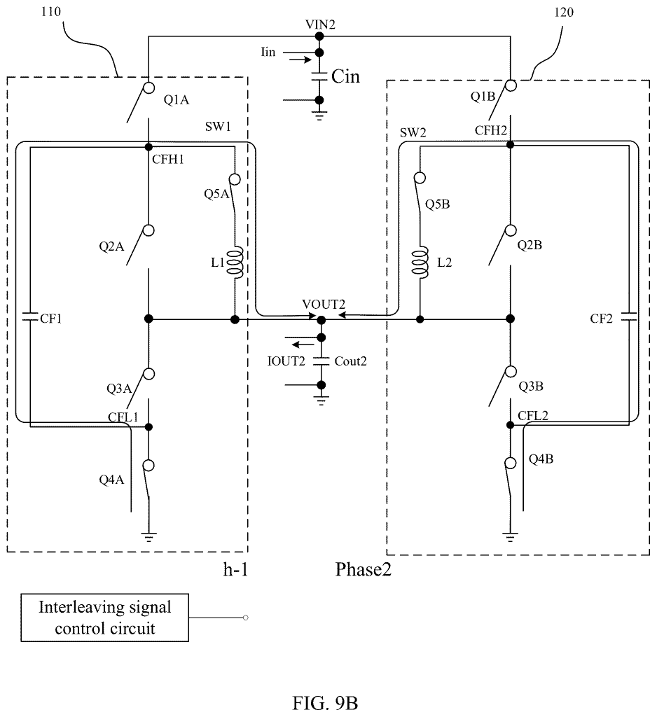

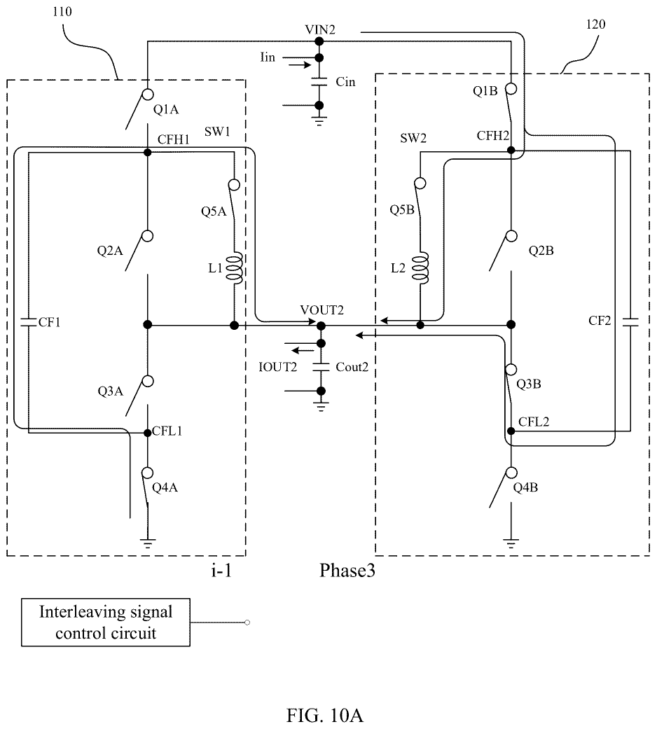

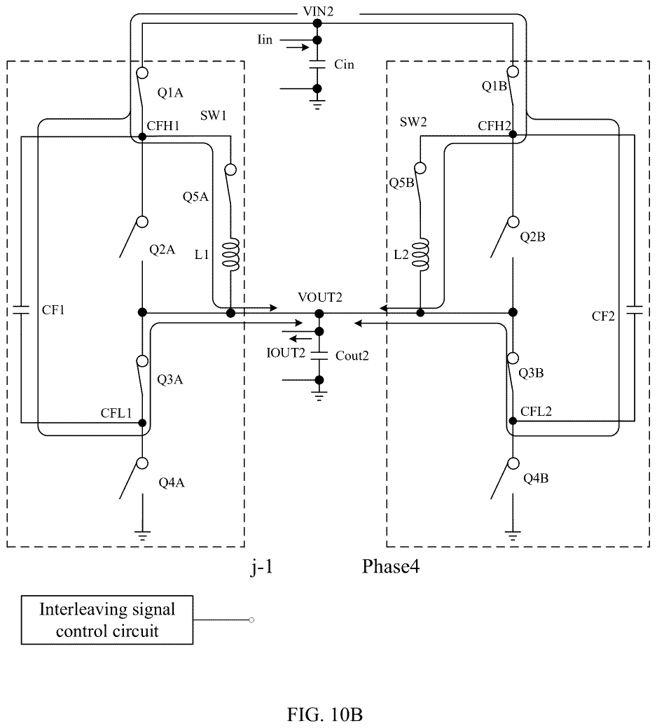

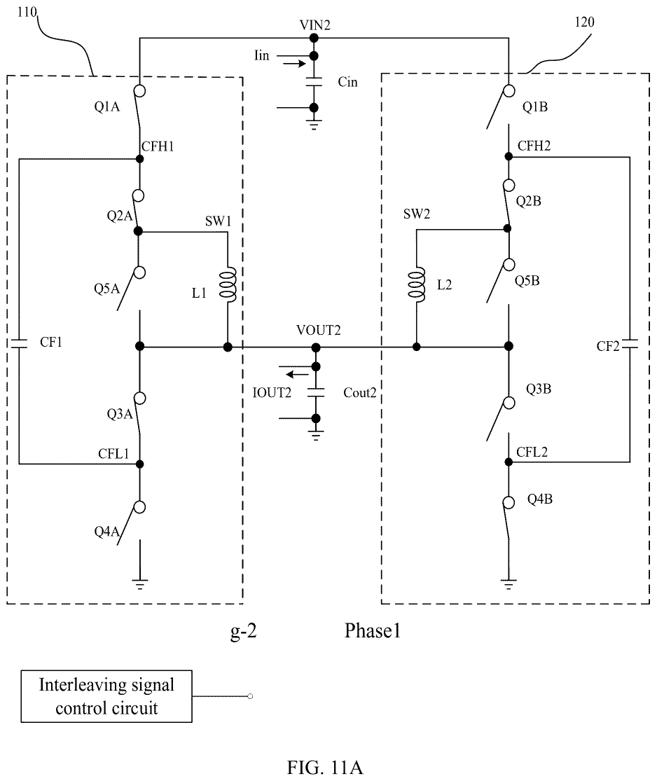

With reference to FIGS. 9A and 9B, and FIGS. 10A and 10B, the four operating phases of the hybrid buck converter 100 in FIG. 6 in the buck mode are described in detail hereinafter.

Referring to FIG. 9A, FIG. 9A is a first schematic diagram of an equivalent circuit structure of the hybrid buck converter in FIG. 6 in the buck mode. As illustrated in FIG. 9A, in a first operating phase Phase1, with respect to the first single-phase buck converter circuit 110, the interleaving signal control circuit controls the first switching transistor Q1A, the third switching transistor Q3A, and the fifth switching transistor Q5A to be turned on, and controls the second switching transistor Q2A and the fourth switching transistor Q4A to be turned off. The input voltage VIN2 at the input terminal supplies power to the output capacitor Cout2 sequentially via a path of the first switching transistor Q1A, the first flying capacitor CF1, and the third switching transistor Q3A, and sequentially via another path of the first switching transistor Q1A, the fifth switching transistor Q5A, and the first inductor L1. The first flying capacitor CF1 is charged, and the first inductor L1 is magnetized. That is, the first single-phase buck converter circuit 110 is in a charging stage.

In the first operating phase Phase1, with respect to the second single-phase buck converter circuit 120, the interleaving signal control circuit controls the ninth switching transistor Q4B and the tenth switching transistor Q5B to be turned on, and controls the sixth switching transistor Q1B, the seventh switching transistor Q2B, and the eighth switching transistor Q3B to be turned off. The second flying capacitor CF2 supplies power to the output capacitor Cout2 sequentially via the tenth switching transistor Q5B and the second inductor L2. The second flying capacitor CF2 is discharged, and the second inductor L2 is demagnetized. That is, the second single-phase buck converter circuit 120 is in a discharging stage.

In summary, in the first operating phase Phase1, the first single-phase buck converter circuit 110 is in the charging stage, and the second single-phase buck converter circuit 120 is in the discharging stage.

Referring to FIG. 9B, FIG. 9B is a second schematic diagram of an equivalent circuit structure of the hybrid buck converter in FIG. 6 in the buck mode. As illustrated in FIG. 9B, in a second operating phase Phase2, with respect to the first single-phase buck converter circuit 110, the interleaving signal control circuit controls the fourth switching transistor Q4A and the fifth switching transistor Q5A to be turned on, and controls the first switching transistor Q1A, the second switching transistor Q2A, and the third switching transistor Q3A to be turned off. The first flying capacitor CF1 supplies power to the output capacitor Cout2 sequentially via the fifth switching transistor Q5A and the first inductor L1. The first flying capacitor CF1 is discharged, and the first inductor L1 is demagnetized. That is, the first single-phase buck converter circuit 110 is in a discharging stage.

In the second operating phase Phase2, with respect to the second single-phase buck converter circuit 120, the interleaving signal control circuit controls the ninth switching transistor Q4B and the tenth switching transistor Q5B to be turned on, and controls the sixth switching transistor Q1B, the seventh switching transistor Q2B, and the eighth switching transistor Q3B to be turned off. The second flying capacitor CF2 supplies power to the output capacitor Cout2 sequentially via the tenth switching transistor Q5B and the second inductor L2. The second flying capacitor CF2 is discharged, and the second inductor L2 is demagnetized. That is, the second single-phase buck converter circuit 110 is in a discharging stage.

In summary, in the second operating phase Phase2, the first single-phase buck converter circuit 110 is in the discharging stage, and the second single-phase buck converter circuit 120 is in the discharging stage.

Referring to FIG. 10A, FIG. 10A is a third schematic diagram of an equivalent circuit structure of the hybrid buck converter in FIG. 6 in the buck mode. As illustrated in FIG. 10A, in a third operating phase Phase3, with respect to the first single-phase buck converter circuit 110, the interleaving signal control circuit controls the fourth switching transistor Q4A and the fifth switching transistor Q5A to be turned on, and controls the first switching transistor Q1A, the second switching transistor Q2A, and the third switching transistor Q3A to be turned off. The first flying capacitor CF1 supplies power to the output capacitor Cout2 sequentially via the fifth switching transistor Q5A and the first inductor L1. The first flying capacitor CF1 is discharged, and the first inductor L1 is demagnetized. That is, the first single-phase buck converter circuit 110 is in a discharging stage.

In the third operating phase Phase3, with respect to the second single-phase buck converter circuit 120, the interleaving signal control circuit controls the sixth switching transistor Q1B, the eighth switching transistor Q3B, and the tenth switching transistor Q5B to be turned on, and controls the seventh switching transistor Q2B and the ninth switching transistor Q4B to be turned off. The input voltage VIN2 at the input terminal supplies power to the output capacitor Cout2 respectively via a path of the sixth switching transistor Q1B, the second flying capacitor CF2, and the eighth switching transistor Q3B, and via another path of the sixth switching transistor Q1B, the tenth switching transistor Q5B, and the second inductor L2. The second flying capacitor CF2 is charged, and the second inductor L2 is magnetized. That is, the second single-phase buck converter circuit 110 is in a charging stage.

In summary, in the third operating phase Phase3, the first single-phase buck converter circuit 110 is in the discharging stage, and the second single-phase buck converter circuit 120 is in the charging stage.

Referring to FIG. 10B, FIG. 10B is a fourth schematic diagram of an equivalent circuit structure of the hybrid buck converter in FIG. 6 in the buck mode. As illustrated in FIG. 10B, in a fourth operating phase Phase4, with respect to the first single-phase buck converter circuit 110, the interleaving signal control circuit controls the first switching transistor Q1A, the third switching transistor Q3A, and the fifth switching transistor Q5A to be turned on, and controls the second switching transistor Q2A and the fourth switching transistor Q4A to be turned off. The input voltage VIN2 at the input terminal supplies power to the output capacitor Cout2 respectively via a path of the first switching transistor Q1A, the first flying capacitor CF1, and the third switching transistor Q3A, and via another path of the first switching transistor Q1A, the fifth switching transistor Q5A, and the first inductor L1. The first flying capacitor CF1 is charged, and the first inductor L1 is magnetized. That is, the first single-phase buck converter circuit 110 is in a charging stage.

In the fourth operating phase Phase4, with respect to the second single-phase buck converter circuit 120, the interleaving signal control circuit controls the sixth switching transistor Q1B, the eighth switching transistor Q3B, and the tenth switching transistor Q5B to be turned on, and controls the seventh switching transistor Q2B and the ninth switching transistor Q4B to be turned off. The input voltage VIN2 at the input terminal supplies power to the output capacitor Cout2 respectively via a path of the sixth switching transistor Q1B, the second flying capacitor CF2, and the eighth switching transistor Q3B, and via another path of the sixth switching transistor Q1B, the tenth switching transistor Q5B, and the second inductor L2. The second flying capacitor CF2 is charged, and the second inductor L2 is magnetized. That is, the second single-phase buck converter circuit 110 is in a charging stage.

In summary, in the fourth operating phase Phase4, the first single-phase buck converter circuit 110 is in the charging stage, and the second single-phase buck converter circuit 120 is in the charging stage.

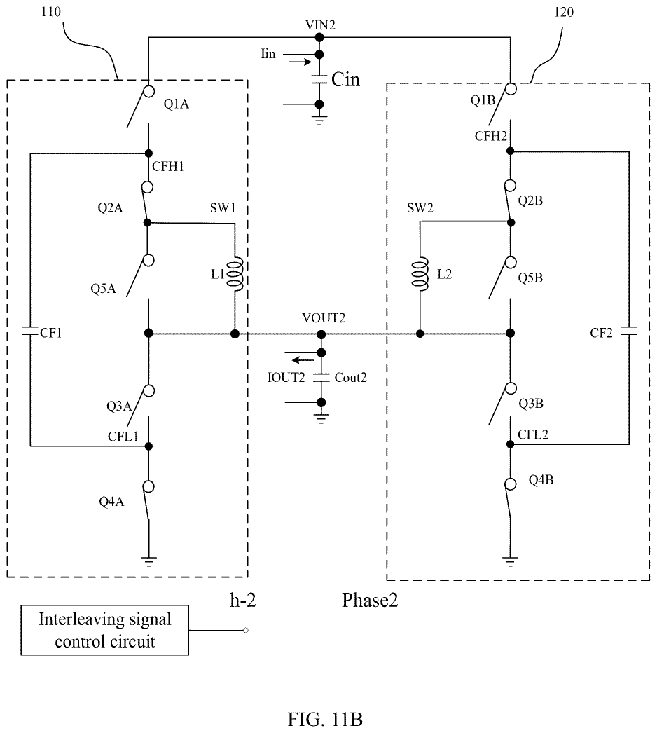

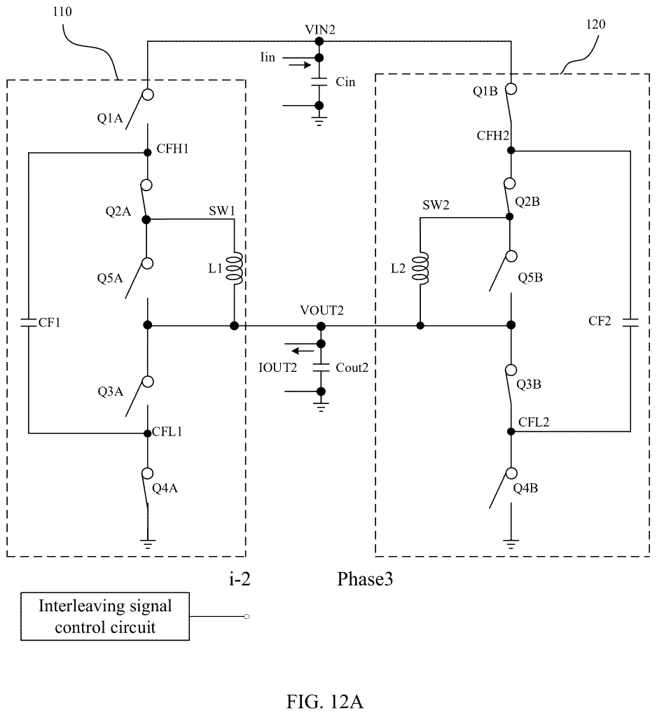

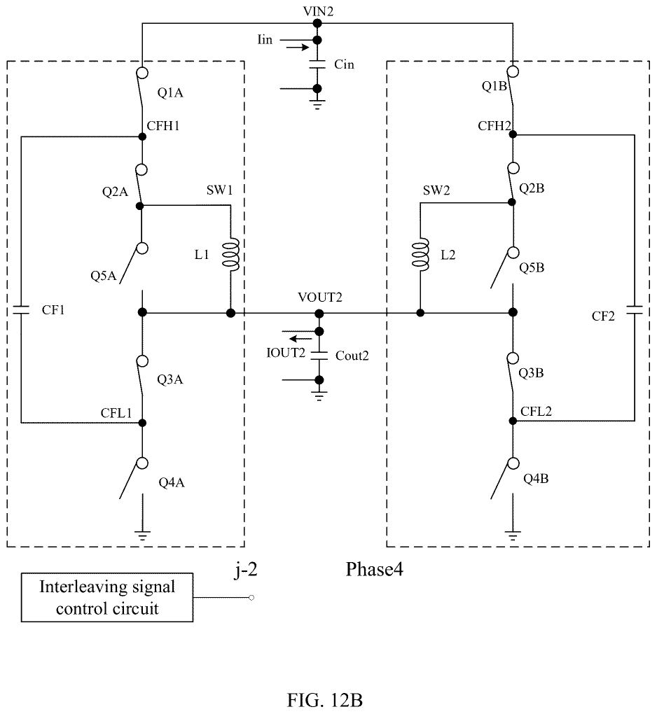

With reference to FIGS. 11A and 11B, and FIGS. 12A and 12B, the four operating phases of the hybrid buck converter 100 in FIG. 7 in the buck mode are described in detail hereinafter.

Referring to FIG. 11A, FIG. 11A is a first schematic diagram of an equivalent circuit structure of the hybrid buck converter in FIG. 7 in the buck mode. As illustrated in FIG. 11A, in a first operating phase Phase1, with respect to the first single-phase buck converter circuit 110, the interleaving signal control circuit controls the first switching transistor Q1A, the second switching transistor Q2A, and the third switching transistor Q3A to be turned on, and controls the fourth switching transistor Q4A and the fifth switching transistor Q5A to be turned off. The input voltage VIN2 at the input terminal supplies power to the output capacitor Cout2 respectively via a path of the first switching transistor Q1A, the first flying capacitor CF1, and the third switching transistor Q3A, and via another path of the first switching transistor Q1A, the second switching transistor Q2A, and the first inductor L1. The first flying capacitor CF1 is charged, and the first inductor L1 is magnetized. That is, the first single-phase buck converter circuit 110 is in a charging stage.

In the first operating phase Phase1, with respect to the second single-phase buck converter circuit 120, the interleaving signal control circuit controls the seventh switching transistor Q2B and the ninth switching transistor Q4B to be turned on, and controls the sixth switching transistor Q1B, the eighth switching transistor Q3B, and the tenth switching transistor Q5B to be turned off. The second flying capacitor CF2 supplies power to the output capacitor Cout2 sequentially via the seventh switching transistor Q2B and the second inductor L2. The second flying capacitor CF2 is discharged, and the second inductor L2 is demagnetized. That is, the second single-phase buck converter circuit 120 is in a discharging stage.

In summary, in the first operating phase Phase1, the first single-phase buck converter circuit 110 is in the charging stage, and the second single-phase buck converter circuit 120 is in the discharging stage.

Referring to FIG. 11B, FIG. 11B is a second schematic diagram of an equivalent circuit structure of the hybrid buck converter in FIG. 7 in the buck mode. As illustrated in FIG. 11B, in a second operating phase Phase2, with respect to the first single-phase buck converter circuit 110, the interleaving signal control circuit controls the second switching transistor Q2A and the fourth switching transistor Q4A to be turned on, and controls the first switching transistor Q1A, the third switching transistor Q3A, and the fifth switching transistor Q5A to be turned off. The first flying capacitor CF1 supplies power to the output capacitor Cout2 sequentially via the second switching transistor Q2A and the first inductor L1. The first flying capacitor CF1 is discharged, and the first inductor L1 is demagnetized. That is, the first single-phase buck converter circuit 110 is in a discharging stage.

In the second operating phase Phase2, with respect to the second single-phase buck converter circuit 120, the interleaving signal control circuit controls the seventh switching transistor Q2B and the ninth switching transistor Q4B to be turned on, and controls the sixth switching transistor Q1B, the eighth switching transistor Q3B, and the tenth switching transistor Q5B to be turned off. The second flying capacitor CF2 supplies power to the output capacitor Cout2 sequentially via the seventh switching transistor Q2B and the second inductor L2. The second flying capacitor CF2 is discharged, and the second inductor L2 is demagnetized. That is, the second single-phase buck converter circuit 110 is in a discharging stage.

In summary, in the second operating phase Phase2, the first single-phase buck converter circuit 110 is in the discharging stage, and the second single-phase buck converter circuit 120 is in the discharging stage.

Referring to FIG. 12A, FIG. 12A is a third schematic diagram of an equivalent circuit structure of the hybrid buck converter in FIG. 7 in the buck mode. As illustrated in FIG. 12A, in a third operating phase Phase3, with respect to the first single-phase buck converter circuit 110, the interleaving signal control circuit controls the second switching transistor Q2A and the fourth switching transistor Q4A to be turned on, and controls the first switching transistor Q1A, the third switching transistor Q3A, and the fifth switching transistor Q5A to be turned off. The first flying capacitor CF1 supplies power to the output capacitor Cout2 sequentially via the second switching transistor Q2A and the first inductor L1. The first flying capacitor CF1 is discharged, and the first inductor L1 is demagnetized. That is, the first single-phase buck converter circuit 110 is in a discharging stage.

In the third operating phase Phase3, with respect to the second single-phase buck converter circuit 120, the interleaving signal control circuit controls the sixth switching transistor Q1B, the seventh switching transistor Q2B, and the eighth switching transistor Q3B to be turned on, and controls the ninth switching transistor Q4B and the tenth switching transistor Q5B to be turned off. The input voltage VIN2 at the input terminal supplies power to the output capacitor Cout2 respectively via a path of the sixth switching transistor Q1B, the second flying capacitor CF2, and the eighth switching transistor Q3B, and via another path of the sixth switching transistor Q1B, the seventh switching transistor Q2B, and the second inductor L2. The second flying capacitor CF2 is charged, and the second inductor L2 is magnetized. That is, the second single-phase buck converter circuit 110 is in a charging stage.

In summary, in the third operating phase Phase3, the first single-phase buck converter circuit 110 is in the discharging stage, and the second single-phase buck converter circuit 120 is in the charging stage.

Referring to FIG. 12B, FIG. 12B is a fourth schematic diagram of an equivalent circuit structure of the hybrid buck converter in FIG. 7 in the buck mode. As illustrated in FIG. 12B, in a fourth operating phase Phase4, with respect to the first single-phase buck converter circuit 110, the interleaving signal control circuit controls the first switching transistor Q1A, the second switching transistor Q2A, and the third switching transistor Q3A to be turned on, and controls the fourth switching transistor Q4A and the fifth switching transistor Q5A to be turned off. The input voltage VIN2 at the input terminal supplies power to the output capacitor Cout2 respectively via a path of the first switching transistor Q1A, the first flying capacitor CF1, and the third switching transistor Q3A, and via another path of the first switching transistor Q1A, the second switching transistor Q2A, and the first inductor L1. The first flying capacitor CF1 is charged, and the first inductor L1 is magnetized. That is, the first single-phase buck converter circuit 110 is in a charging stage.

In the fourth operating phase Phase4, with respect to the second single-phase buck converter circuit 120, the interleaving signal control circuit controls the sixth switching transistor Q1B, the seventh switching transistor Q2B, and the eighth switching transistor Q3B to be turned on, and controls the ninth switching transistor Q4B and the tenth switching transistor Q5B to be turned off. The input voltage VIN2 at the input terminal supplies power to the output capacitor Cout2 respectively via a path of the sixth switching transistor Q1B, the second flying capacitor CF2, and the eighth switching transistor Q3B, and via another path of the sixth switching transistor Q1B, the seventh switching transistor Q2B, and the second inductor L2. The second flying capacitor CF2 is charged, and the second inductor L2 is magnetized. That is, the second single-phase buck converter circuit 110 is in a charging stage.

In summary, in the fourth operating phase Phase4, the first single-phase buck converter circuit 110 is in the charging stage, and the second single-phase buck converter circuit 120 is in the charging stage.

The specific operating phases of the hybrid buck converter 100 in the buck mode are related to the interleaving time between the first single-phase buck converter circuit 110 and the second single-phase buck converter circuit 120, as well as the duty cycle of the hybrid buck converter 100.

In a case where the interleaving time between the first single-phase buck converter circuit 110 and the second single-phase buck converter circuit 120 is not 0 and the duty cycle is greater than 50%, the specific operating phases of the hybrid buck converter 100 are: the first operating phase Phase1, the third operating phase Phase3, and the fourth operating phase Phase4.

In a case where the interleaving time between the first single-phase buck converter circuit 110 and the second single-phase buck converter circuit 120 is not 0 and the duty cycle is equal to 50%, the specific operating phases of the hybrid buck converter 100 are: the first operating phase Phase1 and the third operating phase Phase3.

In a case where the interleaving time between the first single-phase buck converter circuit 110 and the second single-phase buck converter circuit 120 is not 0 and the duty cycle is less than 50%, the specific operating phases of the hybrid buck converter 100 are: the first operating phase Phase1, the second operating phase Phase2, and the third operating phase Phase3.

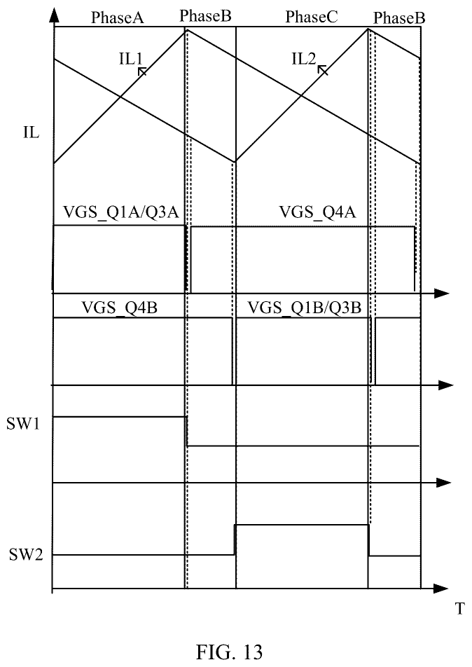

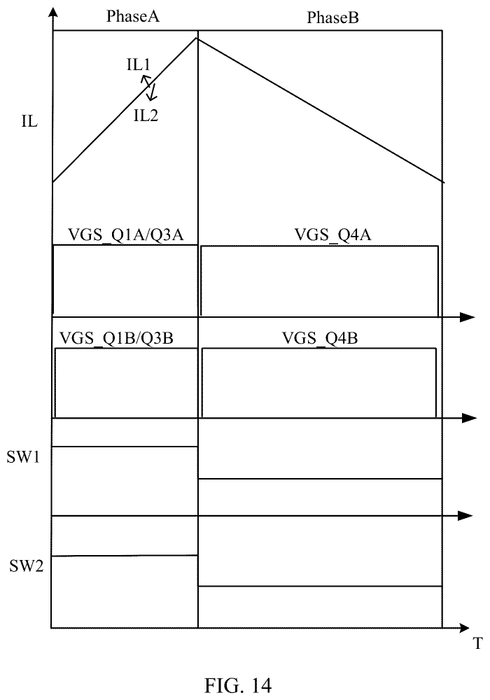

Therefore, with reference to FIGS. 13 and 14, operating waveforms of the hybrid buck converter 100 in the buck mode are described in detail for the cases where the interleaving time is 50% of the period and the duty cycle is less than 50% and where the interleaving time is 0 respectively.

The operating waveforms of the hybrid buck converter in FIG. 7 in the buck mode are similar to those of the hybrid buck converter in FIG. 6. Therefore, for ease of explanation, the embodiments of the present disclosure take the operating waveforms of the hybrid buck converter in FIG. 6 in the buck mode as an example for illustration.

In a case where the interleaving time between the first single-phase buck converter circuit 110 and the second single-phase buck converter circuit 120 is 50% of the period and the duty cycle is less than 50%, the operating waveforms of the hybrid buck converter 100 in the buck mode are as illustrated in FIG. 13. FIG. 13 illustrates a schematic diagram of a first type of operating waveforms of the hybrid buck converter in FIG. 6 in the buck mode.

As illustrated in FIG. 13, in the first operating phase Phase1 (i.e., the phase A stage), with respect to the first single-phase buck converter circuit 110, the first switching transistor Q1A, the third switching transistor Q3A, and the fifth switching transistor Q5A are turned on, wherein the gate-source voltage VGS_Q1A of the first switching transistor Q1A and the gate-source voltage VGS_Q3A of the third switching transistor Q3A are at a high level. The second switching transistor Q2A and the fourth switching transistor Q4A are turned off. The input voltage VIN2 at the input terminal supplies power to the output capacitor Cout2 via the first flying capacitor CF1 and the first inductor L1. The first flying capacitor CF1 is charged, the first inductor L1 is magnetized, and the current IL1 of the first inductor L1 is in a rising stage. During this stage, the voltage at the fifth node SW1 is equal to VIN2, and the magnetization voltage of the first inductor L1 is VIN2−VOUT2.

During this stage, with respect to the second single-phase buck converter circuit 120, the ninth switching transistor Q4B and the tenth switching transistor Q5B are turned on, wherein the gate-source voltage VGS_Q4B of the ninth switching transistor Q4B are at a high level. The sixth switching transistor Q1B, the seventh switching transistor Q2B, and the eighth switching transistor Q3B are turned off. The second flying capacitor CF2 supplies power to the output capacitor Cout2 via the second inductor L2. The second flying capacitor CF2 is discharged, the second inductor L2 is demagnetized, and the current IL2 of the second inductor L2 is in a falling stage. During this stage, the voltage at the sixth node SW2 is equal to VIN2−VOUT2, and the demagnetization voltage of the second inductor L2 is 2VOUT2−VIN2.

In the second operating phase Phase2 (i.e., the phase B stage), with respect to the first single-phase buck converter circuit 110, the fourth switching transistor Q4A and the fifth switching transistor Q5A are turned on, wherein the gate-source voltage VGS_Q4A of the fourth switching transistor Q4A are at a high level. The first switching transistor Q1A, the second switching transistor Q2A, and the third switching transistor Q3A are turned off. The first flying capacitor CF1 supplies power to the output capacitor Cout2 via the first inductor L1. The first flying capacitor CF1 is discharged, the first inductor L1 is demagnetized, and the current IL1 of the first inductor L1 is in a falling stage. During this stage, the voltage at the fifth node SW1 is equal to VIN2−VOUT2, and the demagnetization voltage of the first inductor L1 is 2VOUT2−VIN2.

During this stage, with respect to the second single-phase buck converter circuit 120, the ninth switching transistor Q4B and the tenth switching transistor Q5B are turned on, wherein the gate-source voltage VGS_Q4B of the ninth switching transistor Q4B are at a high level. The sixth switching transistor Q1B, the seventh switching transistor Q2B, and the eighth switching transistor Q3B are turned off. The second flying capacitor CF2 supplies power to the output capacitor Cout2 via the second inductor L2. The second flying capacitor CF2 is discharged, the second inductor L2 is demagnetized, and the current IL2 of the second inductor L2 is in a falling stage. During this stage, the voltage at the sixth node SW2 is equal to VIN2−VOUT2, and the demagnetization voltage of the second inductor L2 is 2VOUT2−VIN2.

In the third operating phase Phase3 (i.e., the phase C stage), with respect to the first single-phase buck converter circuit 110, the fourth switching transistor Q4A and the fifth switching transistor Q5A are turned on, wherein the gate-source voltage VGS_Q4A of the fourth switching transistor Q4A are at a high level. The first switching transistor Q1A, the second switching transistor Q2A, and the third switching transistor Q3A are turned off. The first flying capacitor CF1 supplies power to the output capacitor Cout2 via the first inductor L1. The first flying capacitor CF1 is discharged, the first inductor L1 is demagnetized, and the current IL1 of the first inductor L1 is in a falling stage. During this stage, the voltage at the fifth node SW1 is equal to VIN2−VOUT2, and the demagnetization voltage of the first inductor L1 is 2VOUT2−VIN2.

During this stage, with respect to the second single-phase buck converter circuit 120, the sixth switching transistor Q1B, the eighth switching transistor Q3B, and the tenth switching transistor Q5B are turned on, wherein the gate-source voltage VGS_Q1B of the sixth switching transistor Q1B and the gate-source voltage VGS_Q3B of the eighth switching transistor Q3B are at a high level. The seventh switching transistor Q2B and the ninth switching transistor Q4B are turned off. The input voltage VIN2 at the input terminal supplies power to the output capacitor Cout2 via the second flying capacitor CF2 and the second inductor L2. The second flying capacitor CF2 is charged, the second inductor L2 is magnetized, and the current IL2 of the second inductor L2 is in a rising stage. During this stage, the voltage at the node SW2 is equal to VIN2, and the magnetization voltage of the second inductor L2 is VIN2−VOUT2.

In a case where the interleaving time between the first single-phase buck converter circuit 110 and the second single-phase buck converter circuit 120 is 0, the operating waveforms of the hybrid buck converter 100 in the buck mode are as illustrated in FIG. 14. FIG. 14 illustrates a schematic diagram of another type of operating waveforms of the hybrid buck converter in FIG. 6 in the buck mode.

As illustrated in FIG. 14, in the fourth operating phase Phase4 (i.e., the phase A stage), with respect to the first single-phase buck converter circuit 110, the first switching transistor Q1A, the third switching transistor Q3A, and the fifth switching transistor Q5A are turned on, wherein the gate-source voltage VGS_Q1A of the first switching transistor Q1A and the gate-source voltage VGS_Q3A of the third switching transistor Q3A are at a high level. The second switching transistor Q2A and the fourth switching transistor Q4A are turned off. The input voltage VIN2 at the input terminal supplies power to the output capacitor Cout2 via the first flying capacitor CF1 and the first inductor L1. The first flying capacitor CF1 is charged, the first inductor L1 is magnetized, and the current IL1 of the first inductor L1 is in a rising stage. During this stage, the voltage at the fifth node SW1 is equal to VIN2, and the magnetization voltage of the first inductor L1 is VIN2−VOUT2.

During this stage, with respect to the second single-phase buck converter circuit 120, the sixth switching transistor Q1B, the eighth switching transistor Q3B, and the tenth switching transistor Q5B are turned on, wherein the gate-source voltage VGS_Q1B of the sixth switching transistor Q1B and the gate-source voltage VGS_Q3B of the eighth switching transistor Q3B are at a high level. The seventh switching transistor Q2B and the ninth switching transistor Q4B are turned off. The input voltage VIN2 at the input terminal supplies power to the output capacitor Cout2 via the second flying capacitor CF2 and the second inductor L2. The second flying capacitor CF2 is charged, the second inductor L2 is magnetized, and the current IL2 of the second inductor L2 is in a rising stage. During this stage, the voltage at the sixth node SW2 is equal to VIN2, and the magnetization voltage of the second inductor L2 is VIN2−VOUT2.

In the second operating phase Phase2 (i.e., the phase B stage), with respect to the first single-phase buck converter circuit 110, the fourth switching transistor Q4A and the fifth switching transistor Q5A are turned on, wherein the gate-source voltage VGS_Q4A of the fourth switching transistor Q4A are at a high level. The first switching transistor Q1A, the second switching transistor Q2A, and the third switching transistor Q3A are turned off. The first flying capacitor CF1 supplies power to the output capacitor Cout2 via the first inductor L1. The first flying capacitor CF1 is discharged, the first inductor L1 is demagnetized, and the current IL1 of the first inductor L1 is in a falling stage. During this stage, the voltage at the fifth node SW1 is equal to VIN2−VOUT2, and the demagnetization voltage of the first inductor L1 is 2VOUT2−VIN2.

During this stage, with respect to the second single-phase buck converter circuit 120, the ninth switching transistor Q4B and the tenth switching transistor Q5B are turned on, wherein the gate-source voltage VGS_Q4B of the ninth switching transistor Q4B are at a high level. The sixth switching transistor Q1B, the seventh switching transistor Q2B, and the eighth switching transistor Q3B are turned off. The second flying capacitor CF2 supplies power to the output capacitor Cout2 via the second inductor L2. The second flying capacitor CF2 is discharged, the second inductor L2 is demagnetized, and the current IL2 of the second inductor L2 is in a falling stage. During this stage, the voltage at the sixth node SW2 is equal to VIN2−VOUT2, and the demagnetization voltage of the second inductor L2 is 2VOUT2−VIN2.

In a case where one period of the hybrid buck converter 100 is Ts, the magnetization time of the first inductor L1 is Ton2, the demagnetization time of the second inductor L2 is Toff2, and the duty cycle of the hybrid buck converter 100 is D2 (0<D2<1), then there are Formula (1-1) and Formula (1-2):

$$Ton 2 + Toff 2 = Ts \qquad ( 1 - 1 )$$

$$D 2 * Ts = Ton 2 \qquad ( 1 - 2 )$$

From the volt-second balance, Formula (2) may be derived:

$$Ton 2 * ( VIN 2 - VOUT 2 ) = Toff 2 * ( 2 VOUT 2 - VIN 2 ) \qquad ( 2 )$$

According to Formulas (1-1), (1-2), and (2), the duty cycle D2 may be expressed by Formula (3):

$$D 2 = \frac{2 VOUT 2 - VIN 2}{VOUT 2} \qquad ( 3 )$$

According to Formula (3), the first voltage conversion ratio may be expressed by Formula (4):

$$\frac{VOUT 2}{VIN 2} = \frac{1}{2 - D 2} \qquad ( 4 )$$

According to Formula (4), the hybrid buck converter 100 may regulate the output voltage VOUT2 between VIN2/2 and VIN2 by adjusting the magnitude of the duty cycle D2.

In FIGS. 13 and 14, the second switching transistor Q2A and the seventh switching transistor Q2B are always in a turned-off state, and the fifth switching transistor Q5A and the tenth switching transistor Q5B are always in a turned-on state. Therefore, the turned-on or turned-off states of the second switching transistor Q2A, the seventh switching transistor Q2B, the fifth switching transistor Q5A, and the tenth switching transistor Q5B are not illustrated in FIGS. 13 and 14.

In addition, the implementation forms of the switching transistors in FIGS. 6 to 12 include, but are not limited to, a gallium nitride (GaN) transistor, a bipolar junction transistor (BJT), an insulated gate bipolar transistor (IGBT), a metal-oxide-semiconductor field-effect transistor (MOSFET), a field-controlled thyristor (FCT), a gate turn-off thyristor (GTO), and a transmission gate.

For example, in a case where the switching transistor is a GaN transistor, the control terminal of the switching transistor refers to the gate of the GaN transistor, the first terminal of the switching transistor may be the drain or source of the GaN transistor, and correspondingly, the second terminal of the switching transistor may be the source or drain of the GaN transistor.

For example, in a case where the switching transistor is a BJT, the control terminal of the switching transistor refers to the base of the BJT, the first terminal of the switching transistor may be the collector or emitter of the BJT, and correspondingly, the second terminal of the switching transistor may be the emitter or collector of the BJT.

For example, in a case where the switching transistor is an IGBT, the control terminal of the switching transistor refers to the gate of the IGBT, the first terminal of the switching transistor may be the collector or emitter of the IGBT, and correspondingly, the second terminal of the switching transistor may be the emitter or collector of the IGBT.

For example, in a case where the switching transistor is a MOSFET, the control terminal of the switching transistor refers to the gate of the MOSFET, the first terminal of the switching transistor may be the drain or source of the MOSFET, and correspondingly, the second terminal of the switching transistor may be the source or drain of the MOSFET.

For example, in a case where the switching transistor is an FCT, the control terminal of the switching transistor refers to the gate of the FCT, the first terminal of the switching transistor may be the drain or source of the FCT, and correspondingly, the second terminal of the switching transistor may be the source or drain of the FCT.

For example, in a case where the switching transistor is a GTO, the control terminal of the switching transistor refers to the gate of the GTO, the first terminal of the switching transistor may be the cathode or anode of the GTO, and correspondingly, the second terminal of the switching transistor can be the anode or cathode of the GTO.

For example, in a case where the switching transistor is a transmission gate, the control terminal of the switching transistor refers to a port used to access a gate control signal, the first terminal of the switching transistor may be the input terminal or output terminal of the transmission gate, and correspondingly, the second terminal of the switching transistor may be the output terminal or input terminal of the transmission gate.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A hybrid buck converter, comprising: a first single-phase buck converter circuit, a second single-phase buck converter circuit, and an output capacitor; wherein
the first single-phase buck converter circuit and the second single-phase buck converter circuit are connected in parallel between an input terminal of the hybrid buck converter and a first terminal of the output capacitor, and a second terminal of the output capacitor is electrically connected to a ground terminal of the hybrid buck converter; and
the first single-phase buck converter circuit and the second single-phase buck converter circuit are configured to, in a case where the hybrid buck converter operates in a buck mode, convert an input voltage at the input terminal of the hybrid buck converter according to a first voltage conversion ratio.

2. The hybrid buck converter according to claim 1, wherein the first single-phase buck converter circuit comprises a first flying capacitor, a first switching transistor, a second switching transistor, a third switching transistor, a fourth switching transistor, a fifth switching transistor, and a first inductor; and the second single-phase buck converter circuit comprises a second flying capacitor, a sixth switching transistor, a seventh switching transistor, an eighth switching transistor, a ninth switching transistor, a tenth switching transistor, and a second inductor; wherein
a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the third switching transistor, a second terminal of the third switching transistor is electrically connected to a first terminal of the fourth switching transistor, a second terminal of the fourth switching transistor is grounded, a first terminal of the fifth switching transistor is electrically connected to a first node, wherein the first node is disposed between the second terminal of the first switching transistor and the first terminal of the second switching transistor, a second terminal of the fifth switching transistor is electrically connected to a first terminal of the first inductor, a second terminal of the first inductor is electrically connected between the second terminal of the second switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to the first node, and a second terminal of the first flying capacitor is electrically connected to a second node, wherein the second node is located between the second terminal of the third switching transistor and the first terminal of the fourth switching transistor; and
a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the tenth switching transistor is electrically connected to a third node, wherein the third node is disposed between the second terminal of the sixth switching transistor and the first terminal of the seventh switching transistor, a second terminal of the tenth switching transistor is electrically connected to a first terminal of the second inductor, a second terminal of the second inductor is electrically connected between the second terminal of the seventh switching transistor and the first terminal of the eighth switching transistor, the second terminal of the second inductor is further electrically connected to the output terminal of the hybrid buck converter, a first terminal of the second flying capacitor is electrically connected to the third node, and a second terminal of the second flying capacitor is electrically connected to a fourth node, wherein the fourth node is disposed between the second terminal of the eighth switching transistor and the first terminal of the ninth switching transistor.

3. The hybrid buck converter according to claim 2, wherein the hybrid buck converter further comprises an interleaving signal control circuit, wherein control terminals of the first switching transistor, the second switching transistor, the third switching transistor, the fourth switching transistor, the fifth switching transistor, the sixth switching transistor, the seventh switching transistor, the eighth switching transistor, the ninth switching transistor, and the tenth switching transistor are all electrically connected to the interleaving signal control circuit; wherein
the interleaving signal control circuit is configured to: control the fifth switching transistor and the tenth switching transistor to be always turned on and the second switching transistor and the seventh switching transistor to be always turned off, and control the first switching transistor, the third switching transistor, the fourth switching transistor, the sixth switching transistor, the eighth switching transistor, and the ninth switching transistor to be switched between a turned-on state and a turned-off state, to cause the hybrid buck converter to operate in the buck mode; or control the fifth switching transistor and the tenth switching transistor to be always turned off, and control the first switching transistor, the second switching transistor, the third switching transistor, the fourth switching transistor, the sixth switching transistor, the seventh switching transistor, the eighth switching transistor, and the ninth switching transistor to be switched between the turned-on state and the turned-off state, to cause the hybrid buck converter to operate in a switched-capacitor mode.

4. The hybrid buck converter according to claim 1, wherein the first single-phase buck converter circuit and the second single-phase buck converter circuit operate in an interleaved manner; and an interleaving angle between the first single-phase buck converter circuit and the second single-phase buck converter circuit is between 0° and 180°.

5. The hybrid buck converter according to claim 2, wherein the hybrid buck converter supports four operating phases in the buck mode; wherein
in a first operating phase: the first switching transistor, the third switching transistor, and the fifth switching transistor are in a turned-on state, the second switching transistor and the fourth switching transistor are in a turned-off state, the input voltage supplies power to the output capacitor sequentially via a path of the first switching transistor, the first flying capacitor and the third switching transistor and via a path of the first switching transistor, the fifth switching transistor and the first inductor, the first flying capacitor is charged, and the first inductor is magnetized; and the ninth switching transistor and the tenth switching transistor are in the turned-on state, the sixth switching transistor, the seventh switching transistor, and the eighth switching transistor are in the turned-off state, the second flying capacitor supplies power to the output capacitor via the tenth switching transistor and the second inductor, the second flying capacitor is discharged, and the second inductor is demagnetized;
in a second operating phase: the fourth switching transistor and the fifth switching transistor are in the turned-on state, the first switching transistor, the second switching transistor, and the third switching transistor are in the turned-off state, the first flying capacitor supplies power to the output capacitor via the fifth switching transistor and the first inductor, the first flying capacitor is discharged, and the first inductor is demagnetized; and the ninth switching transistor and the tenth switching transistor are in the turned-on state, the sixth switching transistor, the seventh switching transistor, and the eighth switching transistor are in the turned-off state, the second flying capacitor supplies power to the output capacitor via the tenth switching transistor and the second inductor, the second flying capacitor is discharged, and the second inductor is demagnetized;
in a third operating phase: the fourth switching transistor and the fifth switching transistor are in the turned-on state, the first switching transistor, the second switching transistor, and the third switching transistor are in the turned-off state, the first flying capacitor supplies power to the output capacitor via the fifth switching transistor and the first inductor, the first flying capacitor is discharged, and the first inductor is demagnetized; and the sixth switching transistor, the eighth switching transistor, and the tenth switching transistor are in the turned-on state, the seventh switching transistor and the ninth switching transistor are in the turned-off state, the input voltage supplies power to the output capacitor sequentially via a path of the sixth switching transistor, the second flying capacitor and the eighth switching transistor and via a path of the sixth switching transistor, the tenth switching transistor and the second inductor, the second flying capacitor is charged, and the second inductor is magnetized; and
in a fourth operating phase: the first switching transistor, the third switching transistor, and the fifth switching transistor are in the turned-on state, the second switching transistor and the fourth switching transistor are in the turned-off state, the input voltage supplies power to the output capacitor sequentially via the path of the first switching transistor, the first flying capacitor and the third switching transistor and via the path of the first switching transistor, the fifth switching transistor and the first inductor, the first flying capacitor is charged, and the first inductor is magnetized; and the sixth switching transistor, the eighth switching transistor, and the tenth switching transistor are in the turned-on state, the seventh switching transistor and the ninth switching transistor are in the turned-off state, the input voltage supplies power to the output capacitor sequentially via the path of the sixth switching transistor, the second flying capacitor and the eighth switching transistor and via the path of the sixth switching transistor, the tenth switching transistor and the second inductor, the second flying capacitor is charged, and the second inductor is magnetized.

6. The hybrid buck converter according to claim 2, wherein
the first single-phase buck converter circuit and the second single-phase buck converter circuit are further configured to, in a case where the hybrid buck converter operates in a switched-capacitor mode, convert the input voltage according to a second voltage conversion ratio.

7. The hybrid buck converter according to claim 6, wherein the hybrid buck converter supports two operating phases in the switched-capacitor mode; wherein
in a first operating phase: the first switching transistor and the third switching transistor are in a turned-on state, the second switching transistor, the fourth switching transistor, and the fifth switching transistor are in a turned-off state, the input voltage supplies power to the output capacitor via the first switching transistor, the first flying capacitor and the third switching transistor, and the first flying capacitor is charged; and the seventh switching transistor and the ninth switching transistor are in the turned-on state, the sixth switching transistor, the eighth switching transistor, and the tenth switching transistor are in the turned-off state, the second flying capacitor supplies power to the output capacitor via the seventh switching transistor, and the second flying capacitor is discharged; and
in a second operating phase: the second switching transistor and the fourth switching transistor are in the turned-on state, the first switching transistor, the third switching transistor, and the fifth switching transistor are in the turned-off state, the first flying capacitor supplies power to the output capacitor via the second switching transistor, and the first flying capacitor is discharged; and the sixth switching transistor and the eighth switching transistor are in the turned-on state, the seventh switching transistor, the ninth switching transistor, and the tenth switching transistor are in the turned-off state, the input voltage supplies power to the output capacitor via the sixth switching transistor, the second flying capacitor and the eighth switching transistor, and the second flying capacitor is charged.

8. The hybrid buck converter according to claim 1, wherein the first single-phase buck converter circuit comprises a first flying capacitor, a first switching transistor, a second switching transistor, a third switching transistor, a fourth switching transistor, a fifth switching transistor, and a first inductor; and the second single-phase buck converter circuit comprises a second flying capacitor, a sixth switching transistor, a seventh switching transistor, an eighth switching transistor, a ninth switching transistor, a tenth switching transistor, and a second inductor; wherein
a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the fifth switching transistor, a second terminal of the fifth switching transistor is electrically connected to a first terminal of the third switching transistor, a second terminal of the third switching transistor is electrically connected to a first terminal of the fourth switching transistor, a second terminal of the fourth switching transistor is grounded, a first terminal of the first inductor is electrically connected between the second terminal of the second switching transistor and the first terminal of the fifth switching transistor, a second terminal of the first inductor is electrically connected between the second terminal of the fifth switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to a first node, wherein the first node is disposed between the second terminal of the first switching transistor and the first terminal of the second switching transistor, and a second terminal of the first flying capacitor is electrically connected a second node, wherein the second node is disposed between the second terminal of the third switching transistor and the first terminal of the fourth switching transistor; and
a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the tenth switching transistor, a second terminal of the tenth switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the second inductor is electrically connected between the second terminal of the seventh switching transistor and the first terminal of the tenth switching transistor, a second terminal of the second inductor is electrically connected between the second terminal of the tenth switching transistor and the first terminal of the eighth switching transistor, the second terminal of the second inductor is further electrically connected to the output terminal of the hybrid buck converter, a first terminal of the second flying capacitor is electrically connected to a third node, wherein the third node is disposed between the second terminal of the sixth switching transistor and the first terminal of the seventh switching transistor, and a second terminal of the second flying capacitor is electrically connected to a fourth node, wherein the fourth node is disposed between the second terminal of the eighth switching transistor and the first terminal of the ninth switching transistor.

9. The hybrid buck converter according to claim 8, wherein the hybrid buck converter further comprises an interleaving signal control circuit, wherein control terminals of the first switching transistor, the second switching transistor, the third switching transistor, the fourth switching transistor, the fifth switching transistor, the sixth switching transistor, the seventh switching transistor, the eighth switching transistor, the ninth switching transistor, and the tenth switching transistor are all electrically connected to the interleaving signal control circuit; wherein
the interleaving signal control circuit is configured to: control the fifth switching transistor and the tenth switching transistor to be always turned off and the second switching transistor and the seventh switching transistor to be always turned on, and control the first switching transistor, the third switching transistor, the fourth switching transistor, the sixth switching transistor, the eighth switching transistor, and the ninth switching transistor to be switched between a turned-on state and a turned-off state, to cause the hybrid buck converter to operate in the buck mode; or control the fifth switching transistor and the tenth switching transistor to be always turned on, and control the first switching transistor, the second switching transistor, the third switching transistor, the fourth switching transistor, the sixth switching transistor, the seventh switching transistor, the eighth switching transistor, and the ninth switching transistor to be switched between the turned-on state and the turned-off state, to cause the hybrid buck converter to operate in a switched-capacitor mode.

10. The hybrid buck converter according to claim 8, wherein the hybrid buck converter supports four operating phases in the buck mode; wherein
in a first operating phase: the first switching transistor, the second switching transistor, and the third switching transistor are in a turned-on state, the fourth switching transistor and the fifth switching transistor are in a turned-off state, the input voltage supplies power to the output capacitor sequentially via a path of the first switching transistor, the first flying capacitor and the third switching transistor and via a path of the first switching transistor, the second switching transistor and the first inductor, the first flying capacitor is charged, and the first inductor is magnetized; and the seventh switching transistor and the ninth switching transistor are in the turned-on state, the sixth switching transistor, the eighth switching transistor, and the tenth switching transistor are in the turned-off state, the second flying capacitor supplies power to the output capacitor via the seventh switching transistor and the second inductor, the second flying capacitor is discharged, and the second inductor is demagnetized;
in a second operating phase: the second switching transistor and the fourth switching transistor are in the turned-on state, the first switching transistor, the third switching transistor, and the fifth switching transistor are in the turned-off state, the first flying capacitor supplies power to the output capacitor via the second switching transistor and the first inductor, the first flying capacitor is discharged, and the first inductor is demagnetized; and the seventh switching transistor and the ninth switching transistor are in the turned-on state, the sixth switching transistor, the eighth switching transistor, and the tenth switching transistor are in the turned-off state, the second flying capacitor supplies power to the output capacitor via the seventh switching transistor and the second inductor, the second flying capacitor is discharged, and the second inductor is demagnetized;
in a third operating phase: the second switching transistor and the fourth switching transistor are in the turned-on state, the first switching transistor, the third switching transistor, and the fifth switching transistor are in the turned-off state, the first flying capacitor supplies power to the output capacitor via the second switching transistor and the first inductor, the first flying capacitor is discharged, and the first inductor is demagnetized; and the sixth switching transistor, the seventh switching transistor, and the eighth switching transistor are in the turned-on state, the ninth switching transistor and the tenth switching transistor are in the turned-off state, the input voltage supplies power to the output capacitor sequentially via a path of the sixth switching transistor, the second flying capacitor and the eighth switching transistor and via a path of the sixth switching transistor, the seventh switching transistor and the second inductor, the second flying capacitor is charged, and the second inductor is magnetized; and
in a fourth operating phase: the first switching transistor, the second switching transistor, and the third switching transistor are in the turned-on state, the fourth switching transistor and the fifth switching transistor are in the turned-off state, the input voltage supplies power to the output capacitor sequentially via the path of the first switching transistor, the first flying capacitor and the third switching transistor and via the path of the first switching transistor, the second switching transistor and the first inductor, the first flying capacitor is charged, and the first inductor is magnetized; and the sixth switching transistor, the seventh switching transistor, and the eighth switching transistor are in the turned-on state, the ninth switching transistor and the tenth switching transistor are in the turned-off state, the input voltage supplies power to the output capacitor sequentially via the path of the sixth switching transistor, the second flying capacitor and the eighth switching transistor and via the path of the sixth switching transistor, the seventh switching transistor and the second inductor, the second flying capacitor is charged, and the second inductor is magnetized.

11. The hybrid buck converter according to claim 8, wherein
the first single-phase buck converter circuit and the second single-phase buck converter circuit are further configured to, in a case where the hybrid buck converter operates in a switched-capacitor mode, convert the input voltage according to a second voltage conversion ratio.

12. The hybrid buck converter according to claim 11, wherein the hybrid buck converter supports two operating phases in the switched-capacitor mode; wherein
in a first operating phase: the first switching transistor, the third switching transistor, and the fifth switching transistor are in a turned-on state, the second switching transistor and the fourth switching transistor are in a turned-off state, the input voltage supplies power to the output capacitor via the first flying capacitor, and the first flying capacitor is charged; and the seventh switching transistor, the ninth switching transistor, and the tenth switching transistor are in the turned-on state, the sixth switching transistor and the eighth switching transistor are in the turned-off state, the second flying capacitor supplies power to the output capacitor, and the second flying capacitor is discharged; and
in a second operating phase: the second switching transistor, the fourth switching transistor, and the fifth switching transistor are in the turned-on state, the first switching transistor and the third switching transistor are in the turned-off state, the first flying capacitor supplies power to the output capacitor, and the first flying capacitor is discharged; and the sixth switching transistor, the eighth switching transistor, and the tenth switching transistor are in the turned-on state, the seventh switching transistor and the ninth switching transistor are in the turned-off state, the input voltage supplies power to the output capacitor via the second flying capacitor, and the second flying capacitor is charged.

13. The hybrid buck converter according to claim 1, further comprising: an input capacitor;
wherein a first terminal of the input capacitor is electrically connected to the input terminal of the hybrid buck converter, and a second terminal of the input capacitor is electrically connected to the ground terminal.

14. A chip, comprising: a hybrid buck converter, wherein the hybrid buck converter comprises: a first single-phase buck converter circuit, a second single-phase buck converter circuit, and an output capacitor; wherein,
the first single-phase buck converter circuit and the second single-phase buck converter circuit are connected in parallel between an input terminal of the hybrid buck converter and a first terminal of the output capacitor, and a second terminal of the output capacitor is electrically connected to a ground terminal of the hybrid buck converter; and
the first single-phase buck converter circuit and the second single-phase buck converter circuit are configured to, in a case where the hybrid buck converter operates in a buck mode, convert an input voltage at the input terminal of the hybrid buck converter according to a first voltage conversion ratio.

15. The chip according to claim 14, wherein the first single-phase buck converter circuit comprises a first flying capacitor, a first switching transistor, a second switching transistor, a third switching transistor, a fourth switching transistor, a fifth switching transistor, and a first inductor; and the second single-phase buck converter circuit comprises a second flying capacitor, a sixth switching transistor, a seventh switching transistor, an eighth switching transistor, a ninth switching transistor, a tenth switching transistor, and a second inductor; wherein
a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the third switching transistor, a second terminal of the third switching transistor is electrically connected to a first terminal of the fourth switching transistor, a second terminal of the fourth switching transistor is grounded, a first terminal of the fifth switching transistor is electrically connected to a first node, wherein the first node is disposed between the second terminal of the first switching transistor and the first terminal of the second switching transistor, a second terminal of the fifth switching transistor is electrically connected to a first terminal of the first inductor, a second terminal of the first inductor is electrically connected between the second terminal of the second switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to the first node, and a second terminal of the first flying capacitor is electrically connected to a second node, wherein the second node is located between the second terminal of the third switching transistor and the first terminal of the fourth switching transistor; and
a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the tenth switching transistor is electrically connected to a third node, wherein the third node is disposed between the second terminal of the sixth switching transistor and the first terminal of the seventh switching transistor, a second terminal of the tenth switching transistor is electrically connected to a first terminal of the second inductor, a second terminal of the second inductor is electrically connected between the second terminal of the seventh switching transistor and the first terminal of the eighth switching transistor, the second terminal of the second inductor is further electrically connected to the output terminal of the hybrid buck converter, a first terminal of the second flying capacitor is electrically connected to the third node, and a second terminal of the second flying capacitor is electrically connected to a fourth node, wherein the fourth node is disposed between the second terminal of the eighth switching transistor and the first terminal of the ninth switching transistor.

16. The chip according to claim 15, wherein the hybrid buck converter further comprises an interleaving signal control circuit, wherein control terminals of the first switching transistor, the second switching transistor, the third switching transistor, the fourth switching transistor, the fifth switching transistor, the sixth switching transistor, the seventh switching transistor, the eighth switching transistor, the ninth switching transistor, and the tenth switching transistor are all electrically connected to the interleaving signal control circuit; wherein
the interleaving signal control circuit is configured to: control the fifth switching transistor and the tenth switching transistor to be always turned on and the second switching transistor and the seventh switching transistor to be always turned off, and control the first switching transistor, the third switching transistor, the fourth switching transistor, the sixth switching transistor, the eighth switching transistor, and the ninth switching transistor to be switched between a turned-on state and a turned-off state, to cause the hybrid buck converter to operate in the buck mode; or control the fifth switching transistor and the tenth switching transistor to be always turned off, and control the first switching transistor, the second switching transistor, the third switching transistor, the fourth switching transistor, the sixth switching transistor, the seventh switching transistor, the eighth switching transistor, and the ninth switching transistor to be switched between the turned-on state and the turned-off state, to cause the hybrid buck converter to operate in a switched-capacitor mode.

17. The chip according to claim 14, wherein the first single-phase buck converter circuit comprises a first flying capacitor, a first switching transistor, a second switching transistor, a third switching transistor, a fourth switching transistor, a fifth switching transistor, and a first inductor; and the second single-phase buck converter circuit comprises a second flying capacitor, a sixth switching transistor, a seventh switching transistor, an eighth switching transistor, a ninth switching transistor, a tenth switching transistor, and a second inductor; wherein
a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the fifth switching transistor, a second terminal of the fifth switching transistor is electrically connected to a first terminal of the third switching transistor, a second terminal of the third switching transistor is electrically connected to a first terminal of the fourth switching transistor, a second terminal of the fourth switching transistor is grounded, a first terminal of the first inductor is electrically connected between the second terminal of the second switching transistor and the first terminal of the fifth switching transistor, a second terminal of the first inductor is electrically connected between the second terminal of the fifth switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to a first node, wherein the first node is disposed between the second terminal of the first switching transistor and the first terminal of the second switching transistor, and a second terminal of the first flying capacitor is electrically connected a second node, wherein the second node is disposed between the second terminal of the third switching transistor and the first terminal of the fourth switching transistor; and
a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the tenth switching transistor, a second terminal of the tenth switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the second inductor is electrically connected between the second terminal of the seventh switching transistor and the first terminal of the tenth switching transistor, a second terminal of the second inductor is electrically connected between the second terminal of the tenth switching transistor and the first terminal of the eighth switching transistor, the second terminal of the second inductor is further electrically connected to the output terminal of the hybrid buck converter, a first terminal of the second flying capacitor is electrically connected to a third node, wherein the third node is disposed between the second terminal of the sixth switching transistor and the first terminal of the seventh switching transistor, and a second terminal of the second flying capacitor is electrically connected to a fourth node, wherein the fourth node is disposed between the second terminal of the eighth switching transistor and the first terminal of the ninth switching transistor.

18. An electronic device, comprising: a chip, wherein the chip comprises: a hybrid buck converter,
wherein the hybrid buck converter comprises: a first single-phase buck converter circuit, a second single-phase buck converter circuit, and an output capacitor; wherein,
the first single-phase buck converter circuit and the second single-phase buck converter circuit are connected in parallel between an input terminal of the hybrid buck converter and a first terminal of the output capacitor, and a second terminal of the output capacitor is electrically connected to a ground terminal of the hybrid buck converter; and
the first single-phase buck converter circuit and the second single-phase buck converter circuit are configured to, in a case where the hybrid buck converter operates in a buck mode, convert an input voltage at the input terminal of the hybrid buck converter according to a first voltage conversion ratio.

19. The electronic device according to claim 18, wherein the first single-phase buck converter circuit comprises a first flying capacitor, a first switching transistor, a second switching transistor, a third switching transistor, a fourth switching transistor, a fifth switching transistor, and a first inductor; and the second single-phase buck converter circuit comprises a second flying capacitor, a sixth switching transistor, a seventh switching transistor, an eighth switching transistor, a ninth switching transistor, a tenth switching transistor, and a second inductor; wherein
a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the third switching transistor, a second terminal of the third switching transistor is electrically connected to a first terminal of the fourth switching transistor, a second terminal of the fourth switching transistor is grounded, a first terminal of the fifth switching transistor is electrically connected to a first node, wherein the first node is disposed between the second terminal of the first switching transistor and the first terminal of the second switching transistor, a second terminal of the fifth switching transistor is electrically connected to a first terminal of the first inductor, a second terminal of the first inductor is electrically connected between the second terminal of the second switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to the first node, and a second terminal of the first flying capacitor is electrically connected to a second node, wherein the second node is located between the second terminal of the third switching transistor and the first terminal of the fourth switching transistor; and
a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the tenth switching transistor is electrically connected to a third node, wherein the third node is disposed between the second terminal of the sixth switching transistor and the first terminal of the seventh switching transistor, a second terminal of the tenth switching transistor is electrically connected to a first terminal of the second inductor, a second terminal of the second inductor is electrically connected between the second terminal of the seventh switching transistor and the first terminal of the eighth switching transistor, the second terminal of the second inductor is further electrically connected to the output terminal of the hybrid buck converter, a first terminal of the second flying capacitor is electrically connected to the third node, and a second terminal of the second flying capacitor is electrically connected to a fourth node, wherein the fourth node is disposed between the second terminal of the eighth switching transistor and the first terminal of the ninth switching transistor.

20. The electronic device according to claim 18, wherein the first single-phase buck converter circuit comprises a first flying capacitor, a first switching transistor, a second switching transistor, a third switching transistor, a fourth switching transistor, a fifth switching transistor, and a first inductor; and the second single-phase buck converter circuit comprises a second flying capacitor, a sixth switching transistor, a seventh switching transistor, an eighth switching transistor, a ninth switching transistor, a tenth switching transistor, and a second inductor; wherein
a first terminal of the first switching transistor is electrically connected to the input terminal of the hybrid buck converter, a second terminal of the first switching transistor is electrically connected to a first terminal of the second switching transistor, a second terminal of the second switching transistor is electrically connected to a first terminal of the fifth switching transistor, a second terminal of the fifth switching transistor is electrically connected to a first terminal of the third switching transistor, a second terminal of the third switching transistor is electrically connected to a first terminal of the fourth switching transistor, a second terminal of the fourth switching transistor is grounded, a first terminal of the first inductor is electrically connected between the second terminal of the second switching transistor and the first terminal of the fifth switching transistor, a second terminal of the first inductor is electrically connected between the second terminal of the fifth switching transistor and the first terminal of the third switching transistor, the second terminal of the first inductor is further electrically connected to an output terminal of the hybrid buck converter, the output terminal of the hybrid buck converter is electrically connected to the first terminal of the output capacitor, a first terminal of the first flying capacitor is electrically connected to a first node, wherein the first node is disposed between the second terminal of the first switching transistor and the first terminal of the second switching transistor, and a second terminal of the first flying capacitor is electrically connected a second node, wherein the second node is disposed between the second terminal of the third switching transistor and the first terminal of the fourth switching transistor; and
a first terminal of the sixth switching transistor is electrically connected to the input terminal of the hybrid buck converter, a second terminal of the sixth switching transistor is electrically connected to a first terminal of the seventh switching transistor, a second terminal of the seventh switching transistor is electrically connected to a first terminal of the tenth switching transistor, a second terminal of the tenth switching transistor is electrically connected to a first terminal of the eighth switching transistor, a second terminal of the eighth switching transistor is electrically connected to a first terminal of the ninth switching transistor, a second terminal of the ninth switching transistor is grounded, a first terminal of the second inductor is electrically connected between the second terminal of the seventh switching transistor and the first terminal of the tenth switching transistor, a second terminal of the second inductor is electrically connected between the second terminal of the tenth switching transistor and the first terminal of the eighth switching transistor, the second terminal of the second inductor is further electrically connected to the output terminal of the hybrid buck converter, a first terminal of the second flying capacitor is electrically connected to a third node, wherein the third node is disposed between the second terminal of the sixth switching transistor and the first terminal of the seventh switching transistor, and a second terminal of the second flying capacitor is electrically connected to a fourth node, wherein the fourth node is disposed between the second terminal of the eighth switching transistor and the first terminal of the ninth switching transistor.
